(19) United States
(12) Patent Application Publication
(10) Pub. No.: US 2012/0146525 A1
(43) Pub. Date: Jun. 14, 2012

(54) APPARATUS AND METHODS OF OPERATION OF PASSIVE AND ACTIVE LED LIGHTING EQUIPMENT

(75) Inventors: Shu Yuen Ron Hui, New Territories (CN); Wu Chen, Jiangning (CN)

(73) Assignee: CITY UNIVERSITY OF HONG KONG, Kowloon (HK)

(21) Appl. No.: 13/129,793

(22) PCT Filed: Aug. 20, 2010
(86) PCT No.: PCT/IB2010/002052

§ 371 Date: Jul. 26, 2011

Related U.S. Application Data
(63) Continuation-in-part of application No. 12/582,620, filed on Oct. 20, 2009.
Application No. 12/582,620 is a continuation-in-part of application No. 12/544,545, filed on Aug. 20, 2009.
Application No. 12/544,545 is a continuation-in-part of application No. 12/474,001, filed on May 28, 2009, now abandoned.
Application No. 12/474,001 is a continuation-in-part of application No. 12/429,792, filed on Apr. 24, 2009, now abandoned.

(30) Foreign Application Priority Data
Apr. 21, 2010 (IB) PCT/IB2010/000891

(51) Int. Cl. H05B 37/02

(52) U.S. Cl. 315/200 R

(57) ABSTRACT

This invention is concerned with the control and design of a passive or an active LED lighting system that does not need electrolytic capacitors in the entire system and can generate light output with reduced luminous flux fluctuation. The proposal is particularly suitable, but not restricted to, off-line applications in which the lighting system is powered by the ac mains. By eliminating electrolytic capacitors which have a limited lifetime of typically 15,000 hours, the proposed system can be developed with robust electrical components such as inductor and diode circuits, and it features long lifetime, low maintenance cost, robustness against extreme temperature variations and good power factor. The proposed circuits can become dimmable systems if the AC input voltage can be adjusted by external means.

### FIELD OF THE INVENTION

This invention relates to apparatus and methods for the operation of light emitting diode (LED) lighting equipment, including those that utilize passive or active drivers.

### BACKGROUND OF THE INVENTION

LED technology has been promoted as a promising lighting technology to replace energy-inefficient incandescent lamps and mercury-based linear and compact fluorescent lamps. It is often claimed by LED manufacturers that the LED devices have a long lifetime that could be higher than 5 years. However, the electrolytic capacitors used in the power circuit and the electronic controls for LED systems have a limited lifetime, typically 15000 hours (or 1.7 years) at an operating temperature of 105° C. The lifetime of an electrolytic capacitor is highly sensitive to the operating temperature. The lifetime is doubled if the operating temperature is decreased by 10° C. and halved if increased by 10° C. Therefore, the short lifetime of electronic control circuits (sometimes known as ballasts) for LEDs remains one major bottleneck in the utilization of LED technology [Chung, H. S.-H.; Ho, N.-M.; Yan, W.; Tam, P. W.; Hui, S. Y.; “Comparison of Dimmable Electromagnetic and Electronic Ballast Systems—An Assessment on Energy Efficiency and Lifetime”, IEEE Transactions on Industrial Electronics, Volume 54, Issue 6, December 2007 Page(s):3145-3154; Hui S. Y. R. and Yan W., “Re-examination on Energy Saving & Environmental Issues in Lighting Applications”, Proceedings of the 11^{th} International Symposium on Science 7 Technology of Light Sources, May 2007, Shanghai, China (Invited Landmark Presentation), pp. 373-374].

In general, electrolytic capacitors are used in power inverter circuits and electronic control circuits for lighting systems because they provide the necessary large capacitance of the order of hundreds and even thousands of micro-Farads, while other more long-lasting capacitors such as ceramic, polypropylene and metalized plastic film capacitors have relatively less capacitance of several tens of micro-Farads or less. The large capacitance of electrolytic capacitors is usually needed to provide a stable dc link voltage for the ballast circuit to provide stable power (with reduced power variation) for the load; a stable dc power supply in the electronic control for the power inverter circuit.

### PRIOR ART

FIG. 1 shows the schematic of a typical off-line lighting system. An off-line system here means a system that can be powered by the ac mains. The power conversion circuit can adopt a two-stage approach in which an AC-DC power stage with power factor correction is used as the first power stage, which is followed by a second DC-DC power conversion stage for controlling the current for LED load. An alternative to the two-stage approach is to employ a single-stage approach which combines the two power stages into one and such a technique has been reported in many off-line power supply designs [Reis, F. S. D.; Lima, J. C.; Tonkoski, R., Jr.; Canalli, V. M.; Ramos, F. M.; Santos, A.; Toss, M.; Sarmanho, U.; Edar, F.; Lorenzoni, L.;, “Single stage ballast for high pressure sodium lamps”, IECON 2004. 30th Annual Conference of IEEE Industrial Electronics Society, 2004. Volume 3, 2-6 Nov. 2004 Page(s):2888-2893; Jinrong Qian; Lee, F. C.; “A high efficient single stage single switch high power factor AC/DC converter with universal input”, Twelfth Annual Applied Power Electronics Conference and Exposition, 1997. APEC '97 Conference Proceedings 1997, Volume 1, 23-27 Feb. 1997 Page(s):281-287; Qiao, C.; Smedley, K. M.; “A topology survey of single-stage power factor corrector with a boost type input-current-shaper”, IEEE Transactions on Power Electronics, Volume 16, Issue 3, May 2001 Page(s):360-368; Tse, C. K.; Chow, M. H. L.; “Single stage high power factor converter using the Sheppard-Taylor topology”, 27th Annual IEEE Power Electronics Specialists Conference, 1996. PESC '96 Record., Volume 2, 23-27 Jun. 1996 Page(s):1191-1197]. In both approaches, electrolytic capacitors are used to provide the energy storage and buffer so that the difference between the input power and the output power consumed by the load can be stored or delivered by the capacitors.

It has also been proposed to use rectified ac current at twice the mains frequency to drive the LED load in order to reduce the energy storage requirement, and thus eliminate the use of electrolytic capacitors and keep a high input power factor [L. Gu, X. Ruan, M. Xu and K. Yao, “Means of Eliminating Electrolytic Capacitor in AC/DC Power Supplies for LED Lightings”, IEEE Transactions on Power Electronics, Volume 24, Number 5, May 2009, pp. 1399-1408; and also in ST Microelectronics Application Note AN2711 April 2009]. However, such a proposal basically focuses on the EMC regulatory performance of the electronic LED drivers without due consideration for the photometric performance of the LED systems. The drawback is that LED loads driven by rectified ac current (or current pulses) at twice the mains frequency do not have continuous luminous flux, and suffer from severe flickering effects because of the change of LED power from peak power to zero power at low frequency. For example, the flickering effect at 100 Hz (twice the frequency of 50 Hz) is not acceptable.

Regardless of whether a single-stage or a two-stage approach is used, a large capacitance (requiring the use of electrolytic capacitors) is needed as energy storage to cater for the difference between the input power from the ac mains and the almost constant power of the LED load. The input power of an off-line lighting system is typically a periodically pulsating function as shown in FIG. 1. For example, if power factor is close to one, the input voltage and current are in phase and thus the input power follows a pulsating waveform (similar to a rectified sinusoidal waveform). If the lighting load is of constant power, then the capacitors are needed to absorb or deliver the difference in power between the ac mains and the lighting load as shown in FIG. 1.

An electronic ballast circuit without the use of electrolytic capacitors has been proposed. But the requirement for active power switches, in such proposal means that an electronic control board that provides the switching signals for the active power switches is needed and this electronic control board needs a power supply that requires the use of electrolytic capacitors. In general, electrolytic capacitors are needed in a dc power supply for providing the hold-up time (i.e. to keep the dc voltage for a short period of time when the input power source fails.) Power electronic circuits that use active switches usually need a dc power supply for the gate drive circuits that provide switching signals for the active electronic switches. Therefore, it would be useful if passive and electronic ballast circuits without the need for any electrolytic capacitors can be developed for providing a stable current source for the LED load. A passive or an electronic ballast circuit (also known as an active ballast circuit) without electrolytic capacitors would be a highly robust and reliable solution that enhances the lifetime of the entire LED system. The remaining challenge is to determine how to provide a stable current source for the LED load based on a circuit that does not need any electrolytic capacitors.

### SUMMARY OF THE INVENTION

According to a first aspect of the present invention, there is provided an LED lighting system comprising: a driver for receiving an AC input power and generating an output power, the driver having an energy storage element for storing the AC input power as stored power when the AC input power is higher than required to generate the output power, and for delivering the stored power when the AC input power is lower than required to generate the output power; and at least one LED receiving the output power. The driver allows the output power to vary a predetermined amount such that the at least one LED provides continuous flux as observable to the human eye, and the energy storage element has a decreased capacity requirement as the predetermined amount is increased.

Preferably, the output power has an average output power, and in one embodiment, the predetermined amount is up to a maximum of about ±50% of the average output power. In another embodiment, the predetermined amount is up to a maximum of about ±40% of the average output power. In a further embodiment, the maximum difference between the AC input power and the output power is about ±50% of the average output power. In yet another embodiment, the maximum difference between the AC input power and the output power is about ±60% of the average output power. Preferably, the output power is at substantially the same frequency as the AC input power.

A first embodiment of the driver comprises: (a) a rectification circuit for rectifying the AC input power and generating a rectified DC power; (b) a first circuit for reducing the voltage ripple of the rectified DC power; and (c) a second circuit for generating the output power in the form of a current source. The at least one LED receives the current source as an input.

This driver can be used independently of the first aspect described above. Accordingly, a second aspect of the present invention provides an LED lighting system comprising: (a) a rectification circuit for rectifying an AC input power and generating a rectified DC power; (b) a first circuit for reducing the voltage ripple of the rectified DC power; (c) a second circuit for generating a current source; and (d) at least one LED receiving the current source as an input.

The following embodiments and preferred features apply to both the first embodiment of the driver and the second aspect of the invention described above.

In one embodiment, the voltage ripple reducing first circuit is a valley-fill circuit located between the rectification circuit and the second circuit. The valley-fill circuit may include a voltage-doubler.

Preferably, the valley-fill circuit includes a first capacitor and a second capacitor. The capacitances of the first and second capacitors may be the same, or the first and second capacitors may have different capacitances.

Preferably, the system includes a parallel capacitor connected across the output of the valley-fill circuit.

Preferably, the second circuit comprises an inductor. In one embodiment, a capacitor is connected in parallel across the inductor. The second circuit may further function as a current ripple reduction circuit. Such a current ripple reduction circuit may comprise a coupled inductor with a capacitor.

Preferably, means are also provided for controlling or reducing the sensitivity of the LED power to fluctuations in the AC input supply. This may be achieved, for example, by placing an input inductor in series between the AC input supply and the diode rectification circuit. A capacitor may also be provided in parallel between this input inductor and the diode rectification circuit.

In another embodiment, instead of a valley-fill circuit, the first circuit includes an output capacitor connected across said rectification circuit between said rectification circuit and said second circuit.

The input inductor described above may be a variable inductor that is controllable such that the at least one LED is dimmable. The use of a variable inductor may solely be for providing a dimming function, or may be for reducing the sensitivity of the LED power to fluctuations in the AC input supply in combination with providing a dimming function.

With a second embodiment of the driver, the AC input power is provided by an AC input power source. This second embodiment of the driver comprises: (a) a rectification circuit for rectifying the AC input power and generating a rectified DC power; and (b) an input inductor provided in series between the AC input power source and the rectification circuit.

The use of an input inductor as described above may also be useful independently of providing reduction of voltage/current ripple and therefore according to a third aspect of the present invention there is also provided an LED lighting system comprising: (a) an AC input power source providing an AC input power; (b) a rectification circuit for rectifying the AC input power and generating a rectified DC power; and (c) an input inductor provided in series between the AC input power source and the rectification circuit.

The following embodiments and preferred features apply to both the second embodiment of the driver and the third aspect of the invention described above.

Again, a capacitor may be provided in parallel between the inductor and the diode rectification circuit. Also, the input inductor may be a variable conductor that is controllable so that the LED lighting system is dimmable.

In a third embodiment of the driver, instead of the input inductor described above, the driver includes an input capacitor connected in series between the AC input power source and the rectification circuit, in order to reduce the size of the system.

Preferably, the driver includes an anti-surge-component connected in series with the input capacitor. Preferably, the anti-surge-component is an inductor or a temperature-dependent resistor. Also preferably, the system includes a capacitor connected in parallel across the inductor of the second circuit.

The use of such an input capacitor may also be useful independently and therefore according to a fourth aspect of the invention there is also provided an LED lighting system comprising: (a) an AC input power source providing an AC input power; (b) a rectification circuit for rectifying the AC input power and generating a rectified DC power; and (c) an input capacitor provided in series between the AC input power source and the rectification circuit.

Again, the system can include an anti-surge-component connected in series with the input capacitor, with the anti-surge-component preferably being an inductor or a temperature-dependent resistor.

Preferably, with regard to the first aspect of the invention, the operating and/or design parameters of said at least one LED are chosen such that said predetermined amount by which said output power is allowed to vary can be increased.

Viewed from a fifth aspect, the present invention provides a method of operating a LED lighting system comprising the steps of: providing an AC input power; generating an output power for delivery to at least one LED; storing said AC input power as stored power in an energy storage element when said AC input power is higher than required to generate said output power; delivering said stored power from said energy storage element when said AC input power is lower than required to generate said output power; and allowing said output power to vary such that said at least one LED provides continuous flux as observable to the human eye, and said energy storage element has a decreased capacity requirement as said predetermined amount is increased.

Preferably, the output power has an average output power, and in one embodiment, is allowed to vary up to a maximum of about ±50% of the average output power. In another embodiment, the output power is allowed to vary up to a maximum of about ±40% of the average output power. In a further embodiment, the output power is allowed to vary such that the maximum difference between the AC input power and the output power is about ±50% of the average output power. In yet another embodiment, the output power is allowed to vary such that the maximum difference between the AC input power and the output power is about ±60% of the average output power. Preferably, the output power is generated at substantially the same frequency as the AC input power.

In a first embodiment, the method further comprises the steps of: (a) rectifying the AC input voltage to generate a rectified DC power; (b) reducing the voltage ripple of the rectified DC power; (c) generating the output power in the form of a current source from the voltage ripple reduced rectified DC power; and (d) delivering the current source as an input to the at least one LED.

These method steps can be used independently of the fifth aspect of the invention. Accordingly, a sixth aspect of the invention provided a method of operating a LED lighting system, the method comprising the steps of: (a) rectifying an AC input voltage to generate a rectified DC power; (b) reducing the voltage ripple of the rectified DC power; (c) generating a current source from the voltage ripple reduced rectified DC power; and (d) delivering the current source as an input to at least one LED.

The following embodiments and preferred features apply to both the first embodiment of the method and the sixth aspect of the invention described above.

Preferably, the operating and/or design parameters of the at least one LED are chosen such that the amount by which the output power is allowed to vary can be increased.

Preferably, a thermal characteristic of the at least one LED is chosen such that the the amount by which the output power is allowed to vary can be increased. Such a thermal characteristic may comprise the design of the heatsink and/or the provision of forced cooling or natural cooling.

In one embodiment, a valley-fill circuit is used to reduce the voltage ripple of the rectified DC power. The valley-fill circuit may include a voltage-doubler.

Preferably, the valley-fill circuit is provided with a first capacitor and a second capacitor. The capacitances of the first and second capacitors may be the same, or the first capacitor may be selected with a different capacitance to the second capacitor.

Preferably, a parallel capacitor is connected across the output of the valley-fill circuit to further reduce the voltage ripple of the rectified DC power.

In preferred embodiments, the method further comprises the step of reducing the current ripple of said current source. This step may be carried out by providing a current ripple reduction circuit comprising an inductor. Preferably, a capacitor is connected in parallel across the inductor. In another embodiment, such a circuit may comprise a coupled inductor with a capacitor used to reduce the current ripple.

Preferably the sensitivity of the LED power to fluctuations in the AC input supply voltage is also controlled. In one embodiment, the method further comprises providing an input inductor to reduce the sensitivity of the LED power to fluctuations in the AC input voltage before rectifying the AC input voltage.

In another embodiment, instead of using a valley-fill circuit, an output capacitor connected across the rectified DC power is used to reduce the voltage ripple of the rectified DC power.

Preferably, the AC input voltage can be varied so that the LED lighting system is dimmable. This can be done by using a variable inductor in place of the input inductor described above. The use of a variable inductor may solely be for providing a dimming function, or may be for reducing the sensitivity of the LED power to fluctuations in the AC input supply in combination with providing a dimming function.

A second embodiment of the method comprises the steps of: (a) providing an AC input to provide the AC input power; (b) reducing the sensitivity of the output power delivered to the at least one LED to fluctuations in the voltage of the AC input power; and (c) rectifying the AC input power and generating the output power in the form of a rectified DC power that is delivered to the at least one LED.

Controlling and reducing the sensitivity of the LED power to fluctuations in the AC input supply voltage can also be useful independently. Therefore, seventh aspect of the invention provides a method of providing power to a LED lighting system, the method comprising the steps of: (a) providing an AC input to provide an AC input power; (b) reducing the sensitivity of the power delivered to the LED lighting system to fluctuations in the voltage of the AC input power; and (c) rectifying the AC input power and generating a rectified DC power that is delivered to the LED lighting system.

In both the second embodiment of the method and the seventh aspect of the invention, an input inductor is preferably used to reduce the sensitivity of the output power or LED power to fluctuations in the AC input voltage before rectifying the AC input voltage.

In a third embodiment of the method, instead of using an input inductor as described above, the method includes providing an input capacitor connected in series with the AC input before rectifying the AC input voltage, in order to reduce the size of the resulting system.

Preferably, the method includes providing an anti-surge-component connected in series with the input capacitor. The anti-surge-component can be provided as an inductor or a temperature-dependent resistor. Also preferably, capacitor is connected in parallel across the inductor used to reduce the current ripple in the current ripple reduction circuit described above.

The use of such an input capacitor may also be useful independently and therefore according to an eighth aspect of the invention there is also provided a method of providing power to a LED lighting system, the method comprising the steps of (a) providing an AC input to provide an AC input power; (b) providing an input capacitor to receive the AC input power from the AC input; and (c) rectifying the AC input power from the input capacitor and generating a rectified DC power that is provided to the LED lighting system.

Again, the method can include providing an anti-surge-component connected in series with the input capacitor, and the anti-surge-component can be provided as an inductor or a temperature-dependent resistor.

In all of the aspects of the invention described above, the LED lighting system can be passive or active. In aspects that include a driver, the driver can be passive or active. In embodiments with active drivers, the active drivers can comprise a single-stage AC-DC power converter to convert said AC input power into said output power, or a double-stage AC-DC and DC-DC power converter to convert said AC input power to said output power.

Although preferably used for a lighting load, the valley-fill circuit described above can be used more generally to generate a DC output voltage for broader variety of applications.

Therefore, in a ninth broad aspect of the present invention, there is provided a valley-fill circuit for generating a DC output voltage, the circuit including a first capacitor and a second capacitor, wherein the first and second capacitors have different capacitances such that the voltage ripple of the DC output voltage is reduced.

A tenth aspect of the present invention provides a method of generating a DC output by using a valley-fill circuit including a first capacitor and a second capacitor, wherein the first and second capacitors have different capacitances such that a DC output voltage with reduced voltage ripple is generated.

In an eleventh aspect of the invention, there is provided a system including a valley-fill circuit for generating a DC output voltage, said system including a parallel capacitor connected across said valley-fill circuit such that the voltage ripple of the DC output voltage is reduced.

In a twelfth aspect of the invention, there is provided a method of generating a DC output by using a valley-fill circuit and a parallel capacitor connected across said valley-fill circuit such that the DC output voltage is generated with reduced voltage ripple.

### BRIEF DESCRIPTION OF THE DRAWINGS

Some embodiments of the invention will now be described by way of example and with reference to the accompanying drawings, in which:

FIG. 1 shows a schematic and power profiles of a typical off-line LED lighting system according to the prior art,

FIG. 2(a) shows a schematic and “modified” power profiles of an off-line LED lighting system according to an embodiment of the invention,

FIG. 2(b) shows a schematic and “modified” power profiles of an LED lighting system with an active driver according to an embodiment of the invention,

FIGS. 3(a)-(c) show the variation of LED power and luminous flux in an embodiment of the present invention,

FIG. 4 shows a generalized schematic of an off-line passive or active LED driver with a current source output according to embodiments of the present invention,

FIG. 5(a) shows the input and output power profiles of a typical off-line LED lighting system according to the prior art,

FIG. 5(b) shows the profile of the power storage requirement of a typical off-line LED lighting system according to the prior art,

FIG. 6(a) shows the input and output power profiles of an off-line LED lighting system according to the present invention,

FIG. 6(b) shows the profile of the power storage requirement of an off-line LED lighting system according to the present invention,

FIGS. 7(a), (b) and (c) show (a) a schematic diagram of an off-line circuit design for an LED system using an inductor for current ripple reduction, and (b) and (c) using a coupled inductor for current ripple reduction,

FIG. 8 shows a schematic of an example of one possible hardware implementation of the proposed circuit for an off-line LED system using a standard valley-fill circuit,

FIG. 9 shows a model used for simulation of the circuit in FIG. 8,

FIG. 10 shows an example of a proposed circuit with a standard valley-fill circuit for multiple loads,

FIG. 11 shows an example of a proposed circuit using a valley-fill circuit with a voltage doubler for multiple loads,

FIG. 12 shows an LED system according to an embodiment of the invention under a simulation evaluation (L=1H),

FIGS. 13(a) and (b) show (a) simulated input voltage and current of the system of FIG. 12, and (b) simulated input power of the system of FIG. 12,

FIGS. 14(a)-(d) show (a) simulated voltage and current of the LED module for the circuit of FIG. 12, (b) simulated total power for the LED module and for an individual LED in the module for the system in FIG. 12, (c) and (d) two examples of the relationship between a variation of LED power and luminous flux fluctuation for a LED system using 3 W LED devices,

FIG. 15 shows an LED system according to an embodiment of the invention under a simulation evaluation (L=2 H),

FIGS. 16(a)-(d) show (a) simulated voltage and current of the LED module for the circuit of FIG. 15, (b) simulated total power for the LED module and for an individual LED in the module for the system in FIG. 15, (c) and (d) two examples of the relationship between a variation of LED power and luminous flux fluctuation for a LED system using 3 W LED devices,

FIG. 17 shows an embodiment of a LED system with “coupled inductor” of L=2 H under simulation evaluation (L=2 H),

FIGS. 18(a)-(d) show (a) simulated voltage and current of the LED module for the circuit of FIG. 17, (b) simulated total power for the LED module and for an individual LED in the module for the system in FIG. 17, (c) and (d) two examples of the relationship between a variation of LED power and luminous flux fluctuation for a LED system using 3 W LED devices,

FIG. 19 shows a diode-clamp that may be added to each LED string in embodiments of the invention,

FIGS. 20(a) and (b) illustrate the use of the valley-fill circuit in reducing the voltage ripple,

FIG. 21 shows a circuit according to a further embodiment of the invention,

FIGS. 22(a)-(d) show idealized waveforms in the circuit of FIG. 21,

FIG. 23 shows a simplified equivalent circuit of FIG. 21,

FIG. 24 shows a vectorial relationship in the equivalent circuit of FIG. 21,

FIG. 25 shows a circuit according to a still further embodiment of the invention,

FIG. 26 shows a circuit according to a still further embodiment of the invention,

FIG. 27 shows a circuit according to an embodiment of the invention in which the circuit includes a variable inductor Lₛ,

FIG. 28 shows the variable inductor Lₛ of FIG. 27 based on tapping control,

FIG. 29 shows the variable inductor Lₛ of FIG. 27 based on core saturation,

FIG. 30 is a graph showing the output voltage of a diode bridge only circuit,

FIG. 31(a) is a graph showing the output voltage of the circuit of FIG. 21 in which C1=C2=220 μF,

FIG. 31(b) is a graph showing the output voltage of the circuit of FIG. 21 in which C1=C2=22 μF,

FIG. 32 show capacitors C1 and C2 connected in series,

FIG. 33 is a graph showing the output voltage of the circuit of FIG. 21 in which C1=6600 μF and C2=330 μF,

FIG. 34(a) shows a valley-fill circuit according to another embodiment of the invention,

FIG. 34(b) is a graph showing the output voltage of the circuit in FIG. 34(a),

FIG. 35(a) shows a valley-fill circuit according to yet another embodiment of the invention,

FIG. 35(b) is a graph showing the output voltage of the circuit in FIG. 35(a),

FIG. 36(a) shows a valley-fill circuit according to a further embodiment of the invention,

FIG. 36(b) is a graph showing the output voltage of the circuit in FIG. 36(a),

FIG. 37 shows a circuit according to another embodiment of the invention in which the circuit includes a capacitor across the output of the valley-fill circuit,

FIG. 38 shows a circuit according to a further embodiment of the invention in which no valley-fill circuit is utilized,

FIG. 39 shows a circuit according to yet another embodiment of the invention in which the circuit includes an input capacitor,

FIG. 40 shows a variation of the circuit shown in FIG. 39 with a capacitor connected across the output inductor,

FIG. 41 shows a circuit according to a further embodiment of the invention in which the circuit includes a capacitor and a winding for reducing input power sensitivity,

FIG. 42 is a graph showing the phase difference between I_{Ls} and −I_{Cs} of the circuit shown in FIG. 41,

FIG. 43 shows a simplified version of the circuit shown in FIG. 41, and

FIG. 44 is a graph showing the input current I_{Ls} resulting from the circuit shown in FIG. 43.

### DETAILED DESCRIPTION OF PREFERRED EMBODIMENTS

Referring to the figures, the present invention provides an LED lighting system comprising: a driver for receiving an AC input power and generating an output power, the driver having an energy storage element for storing the AC input power as stored power when the AC input power is higher than required to generate the output power, and for delivering the stored power when the AC input power is lower than required to generate the output power; and at least one LED receiving the output power. The driver allows the output power to vary a predetermined amount such that the at least one LED provides continuous flux as observable to the human eye, and the energy storage element has a decreased capacity requirement as the predetermined amount is increased.

The present invention also provides a method of operating a LED lighting system comprising the steps of: providing an AC input power; generating an output power for delivery to at least one LED; storing said AC input power as stored power in an energy storage element when said AC input power is higher than required to generate said output power; delivering said stored power from said energy storage element when said AC input power is lower than required to generate said output power; and allowing said output power to vary such that said at least one LED provides continuous flux as observable to the human eye, and said energy storage element has a decreased capacity requirement as said predetermined amount is increased.

Preferably, the output power has an average output power, and in one embodiment, the predetermined amount is up to a maximum of about ±50% of the average output power. In another embodiment, the predetermined amount is up to a maximum of about ±40% of the average output power. In a further embodiment, the maximum difference between the AC input power and the output power is about ±50% of the average output power. In yet another embodiment, the maximum difference between the AC input power and the output power is about ±60% of the average output power. Preferably, the output power is at substantially the same frequency as the AC input power.

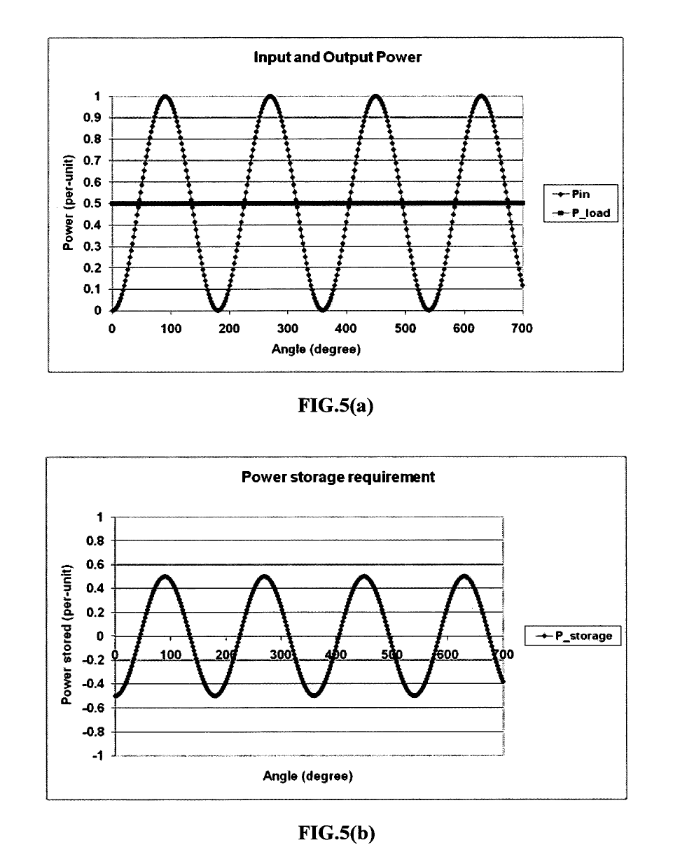

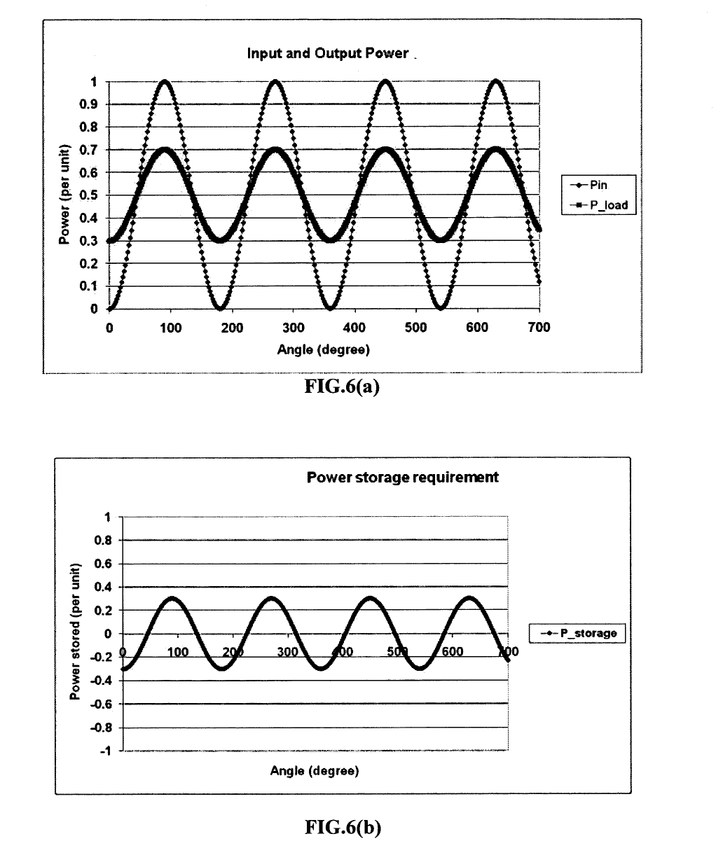

FIG. 6 shows the input and output power profiles and the profile of the energy storage requirement in embodiments where the predetermined amount is up to a maximum of about ±40% of the average output power, and the maximum difference between the AC input power and the output power is about ±60% of the average output power. For comparison, FIG. 5 shows the equivalent profiles for prior systems where the output power is tightly controlled to a constant value.

One important aspect of this invention at least in its preferred forms is to provide a way to reduce the size of the capacitors that is needed so that capacitors other than the electrolytic type can be used. With electrolytic capacitors eliminated in the lighting system, the whole system can be more reliable and last longer.

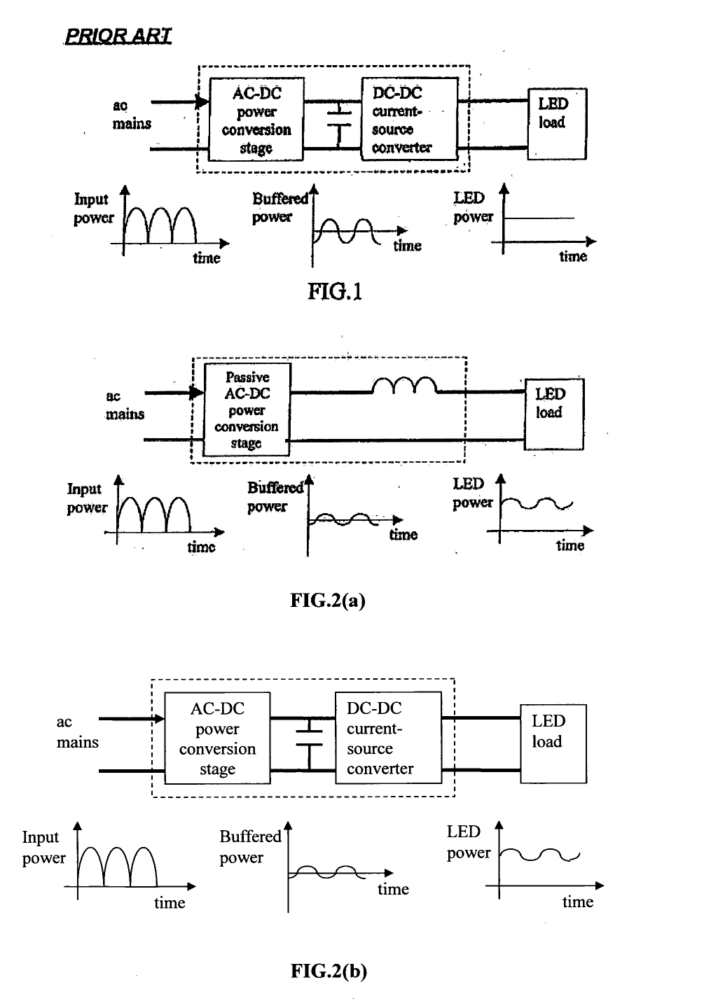

FIGS. 2(a) and (b) are modified versions of FIG. 1 and are used to illustrate this aspect of the invention. If the LED load power is allowed to fluctuate to some extent, the amount of energy buffer required in the energy-storage element of the system becomes less and therefore the size of the capacitance can be reduced to a level that other non-electrolytic capacitors can be used to replace the electrolytic capacitor. Furthermore, complicated control circuitry (which may also require electrolytic capacitors) can also be avoided. FIG. 4 shows a generalized schematic of an off-line passive or active LED driver.

In addition to the elimination of electrolytic capacitors, the design is also concerned with the input power factor because there is an international standard IEC-61000 governing the input power factor. Passive power correction circuits such as valley-fill circuits and their variants [K. Kit Sum, “Improved Valley-Fill Passive Current Shaper”, Power System World 1997, p. 1-8; Lam, J.; Praveen, K.; “A New Passive Valley Fill Dimming Electronic Ballast with Extended Line Current Conduction Angle”, INTELEC '06. 28th Annual International Telecommunications Energy Conference, 2006. 10-14 Sep. 2006 Page(s):1-7] can be used in the passive and active ballast circuits (an active ballast circuits is also called an electronic ballast circuit) in embodiments of this invention such as that shown in FIGS. 2(a) and (b).

Valley-fill circuits allow the input current to be smoothed so that the current distortion factor and thus the input power factor can be improved. The choice of the capacitors used in the valley-fill circuit can be made so that non-electrolytic capacitors can be used. Unlike previous applications, the valley-fill circuit is used in embodiments of this invention to reduce the output voltage ripple which in turn will reduce the current ripple in the later power stage. This aspect of the valley-fill circuit application has not been reported previously because in the prior art valley-fill circuits were primarily used for voltage source applications and were used as a means for input power factor correction with their outputs are nominally connected directly to another power converter or a load. For example, in the National Semiconductor Note: LM3445 Triac Dimmable Offline LED Driver March 2009, the two capacitors C7 and C9 in the valley-fill circuit are electrolytic capacitors and the valley-fill circuit provides a “voltage source” to a buck converter which in turn controls the power of the LED load. Such example of valley-fill circuit application highlights the traditional use of “electrolytic capacitor” in absorbing large power variation and the voltage source nature of prior art.

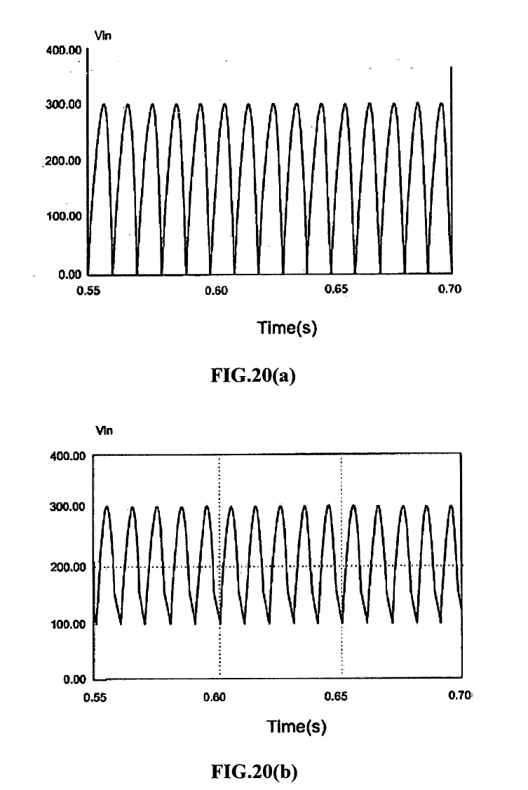

In contrast in embodiments of the present invention valley-fill circuits are used to reduce the output voltage ripple. As shown in FIG. 20(a), the output voltage of the diode rectifier has high voltage ripple. However, the output voltage of the valley-fill circuit is significantly reduced as shown in FIG. 20(b). In embodiments of this invention, the valley-fill circuit is not connected directly to the load or another power converter as in prior art, but is connected directly to an inductor or a coupled-inductor based current ripple cancellation circuit for providing a smooth current to the LED load.

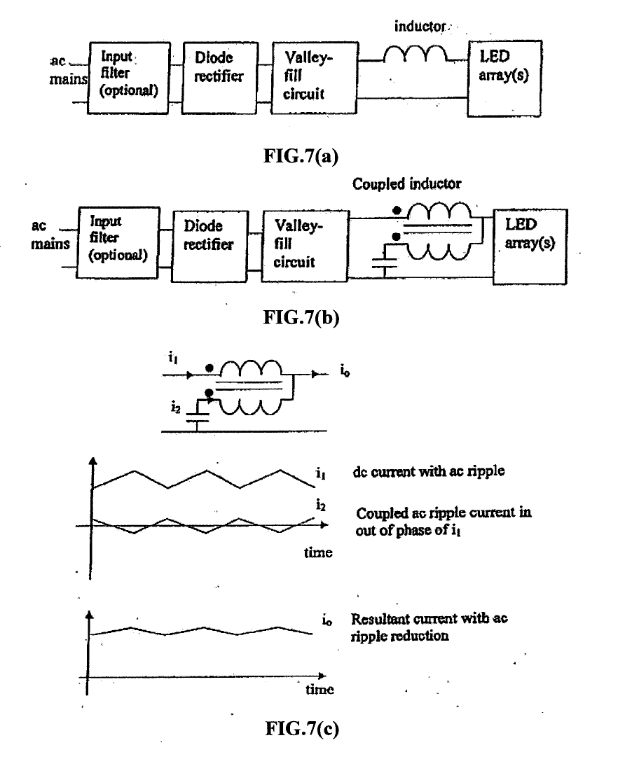

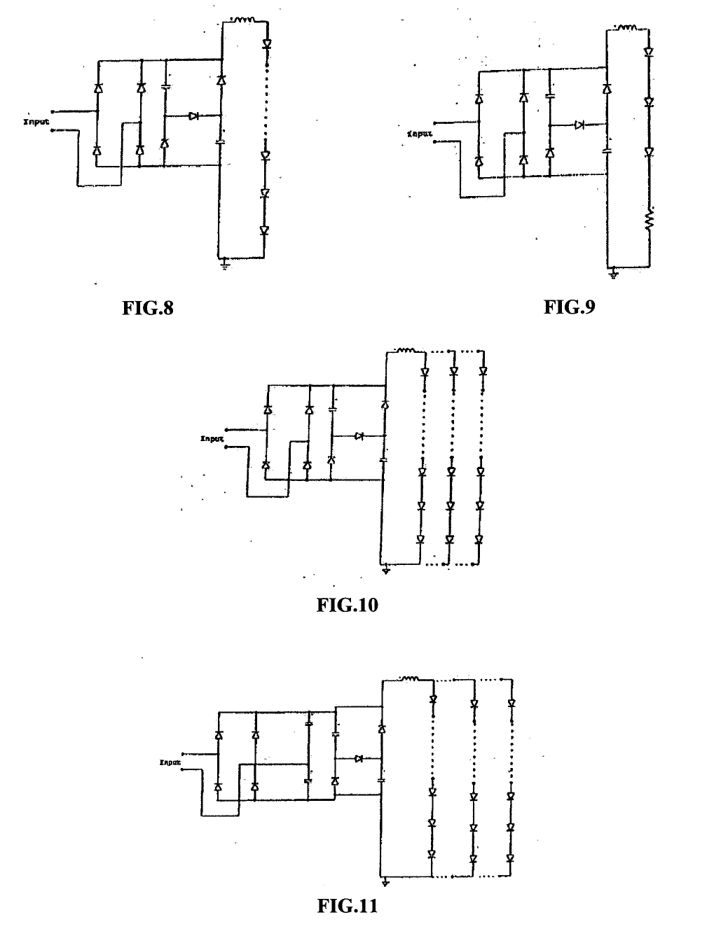

In embodiments of the invention an inductor (FIG. 7(a)) or a coupled inductor with ripple cancellation (FIG. 7(b)) may be used to limit the output current ripple and hence the power variation for the LED load.

FIG. 7(a) and FIG. 7(b) show schematic diagrams of circuits according to embodiments of the invention that can provide high reliability, long lifetime and low cost. Each system consists of a diode rectifier, a valley-fill circuit for improving the input power factor, an inductor for turning the voltage source into a current source with reduced current ripple (FIG. 7(a)) and the LED load. The can form part of passive or active driver circuits. In the case of active circuits, the active components are not specifically indicated but are incorporated in the usual manner. An alternative embodiment as shown in FIG. 7(b) is to replace the inductor in FIG. 7(a) with a coupled inductor and a capacitor so that these components form a coupled inductor with current ripple cancellation function. It will be shown that such current ripple cancellation which is commonly used in high-frequency (greater than 20 kHz) switching power supplies can also be effective in low-frequency operation. The LED load could be an LED array or multiple arrays in modular forms. Various valley-fill circuits or their improved versions can be used to improve the input power factor. In embodiments of this invention, non-electrolytic capacitors can be used in the valley-fill circuit and current-ripple cancellation circuit. Either a standard valley-fill circuit, a valley-fill circuit with voltage doubler or any variant of the valley-fill circuit can be used in this invention.

Considering firstly FIG. 7(a), let the output voltage of the valley-fill circuit be Vₒᵤₜ and the overall voltage of the LED module (with LED devices connected in series) be V_{LED}. The inductance of the inductor can be designed to limit the current through the LED module because the current ripple ΔI_{LED} can be expressed as:

$$Δ {I}_{LED} = \frac{( {V}_{out} - {V}_{LED} ) Δ t}{L}$$

where Δt is the time period during the current change.

From the above equation, it can be seen that the size of the inductor L can be used to reduce the current ripple, which in turn can limit the change of total LED power because

ΔP_{LED}=V_{LED}ΔI_{LED}

An alternative shown in FIG. 7(b) is to use a coupled inductor with current ripple cancellation as described in the art [Hamill, D. C.; Krein, P. T.; “A ‘zero’ ripple technique applicable to any DC converter”, 30th Annual IEEE Power Electronics Specialists Conference, 1999. PESC 99. Volume 2, 27 Jun.-1 Jul. 1999 Page(s):1165-1171; Schutten, M. J.; Steigerwald, R. L.; Sabate, J. A.; “Ripple current cancellation circuit” Eighteenth Annual IEEE Applied Power Electronics Conference and Exposition, 2003. APEC '03. Volume 1, 9-13 Feb. 2003 Page(s):464-470; Cheng, D. K. W.; Liu, X. C.; Lee, Y. S.; “A new improved boost converter with ripple free input current using coupled inductors”, Seventh International Conference on Power Electronics and Variable Speed Drives, 1998. (Conf. Publ. No. 456) 21-23 Sep. 1998 Page(s):592-599 ]. The primary winding of the coupled inductor is used as the dc inductor just as in the embodiment of FIG. 7(a). The secondary winding is coupled to the primary winding and provides the ac current to reduce the ripple in the load. When the primary current in the first inductor is increasing into the dotted terminal of the primary winding (i.e. changing positively), ac flux caused by the increasing primary current is coupled to the secondary ac winding. The transformer action causes a current to flow out of the dotted terminal of the secondary winding into a capacitor in order to cancel the ac flux. Thus, the overall current ripple in the output of the coupled inductor (including both primary and secondary windings) and the load is reduced. Similarly, when the primary current flowing into the dotted terminal of the primary winding is decreasing (i.e. changing negatively), the ac flux coupled to the secondary winding will cause a current to flow into the dotted terminal of the secondary winding and hence reduce the overall current ripple of the couple inductor. The effect of the coupled inductor on reducing the current ripple is illustrated in FIG. 7(c).

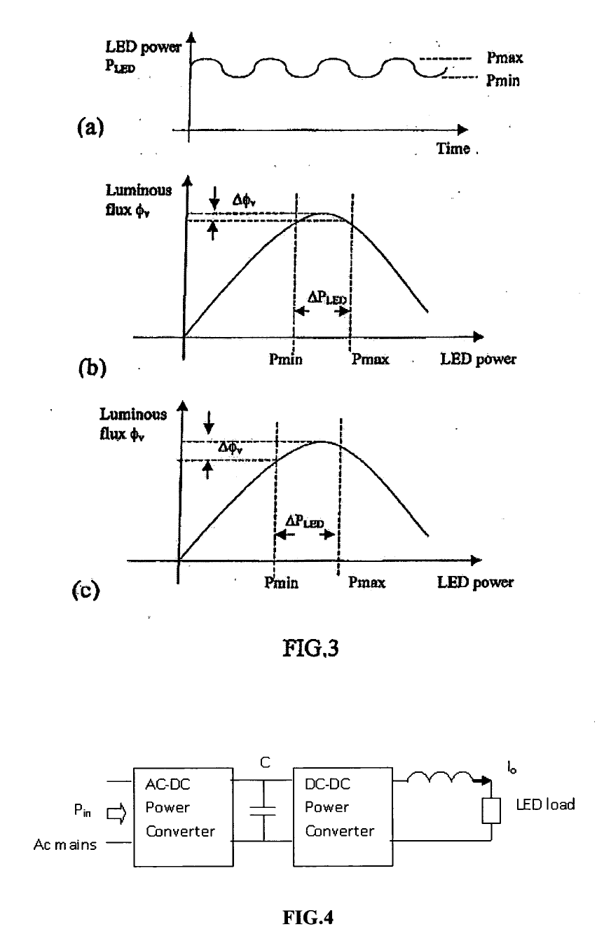

In embodiments of the present invention there will be fluctuation of the LED load power, but it is possible to obtain luminous output from the LED system with minimum luminous flux fluctuation even though the LED load power will fluctuate. This can be seen by considering the relationship between the luminous flux φ_{ν} and LED power P_{d} as shown in FIGS. 3(a)-(c). Let us label the maximum power and minimum power of the LED load as Pmax and Pmin, respectively in FIG. 3(a). It has been shown that the relationship of the luminous flux and the power of a LED system follows an asymmetric parabolic curve as shown in FIG. 3(b) [Hui S. Y. R. and Qin Y. X., “General photo-electro-thermal theory for light-emitting diodes (LED) systems”, IEEE Applied Power Electronics Conference, February 2009, Washington D.C., USA, paper 16.2; U.S. Ser. No. 12/370,101 the contents of which are incorporated herein by reference]. If the LED system is designed such that Pmax and Pmin enclose the peak region of the luminous flux-LED power curve where the slope of the curve is minimum as shown in FIG. 3(b), a significant variation of LED power (ΔP_{LED}) will only lead to a relatively small variation in the luminous flux (Δφ_{ν}). An alternative is to design the LED thermal design so that Pₘₐₓ and Pₘᵢₙ fall within a region of the luminous flux-LED power curve where the slope of the curve is relatively small (i.e. near the peak value) as shown in FIG. 3(c).

As evident from the above, some degree of LED power variation (as shown in FIG. 3), such that the fluctuation of the luminous flux is not noticeable to human eye, is allowed so as to reduce the power difference between the input and the output, and consequently reducing the energy storage requirements and eliminating the need for using electrolytic capacitor in the system.

In this way, the control circuit can use non-electrolytic capacitors without causing a large variation in the light output of the LED system. This concept can be implemented in existing electronic ballasts by replacing the electrolytic capacitors with other capacitors of lower values and re-designing the LED system so that the LED power variation falls within the peak luminous flux region in the luminous flux-LED power curve.

Another aspect of the present invention involves the use of novel passive power circuits that can achieve the advantages proposed above without using active electronic switches. The embodiments shown in FIGS. 7(a), 7(b) and 7(c) can also be applied in fully passive ballast circuits, with similar performance to that shown in FIGS. 3(a), (b) and (c). Without using active electronics switches, these circuits do not need an electronic control circuit for the switches and can be much more reliable, long-lasting and have lower costs than their active electronic counterparts. Of course, these advantages are in addition to the already significant advantages described above in utilizing the present invention in applications where active or electronic ballasts are required.

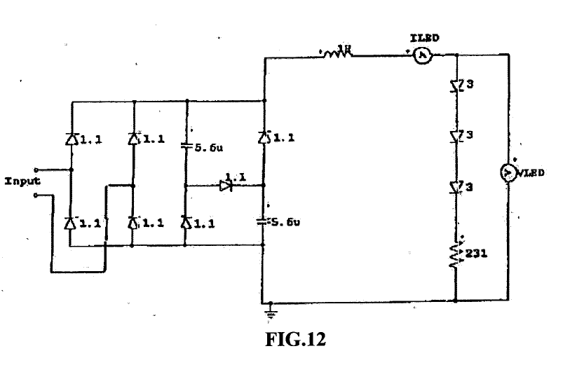

FIG. 8 shows a circuit diagram based on a standard valley-fill circuit. In the actual simulation as shown in FIG. 9, a small number of LED devices are represented by individual diodes and a large number of the LED devices are represented by an equivalent resistor that has the same voltage drop and consumes the same power of that group of LED devices when the rated current flow through these series connected devices. A valley-fill circuit with a voltage doubler as shown in FIG. 10 can also be used if desired. If multiple LED modules are used as shown in FIG. 11, current-balancing devices can be added to ensure that each LED array module shares the same current.

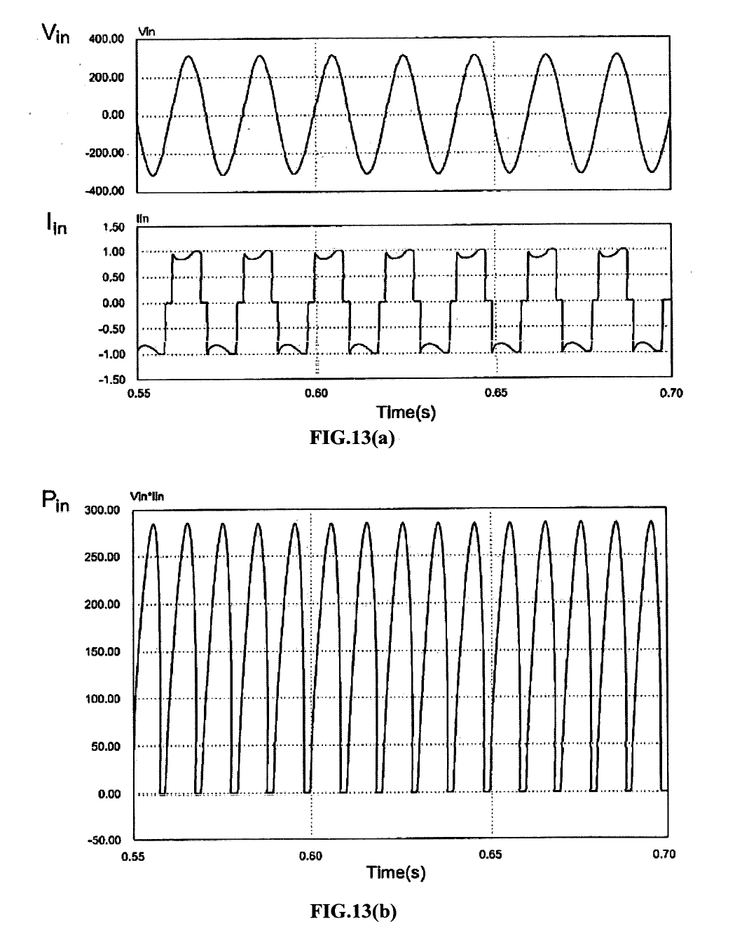

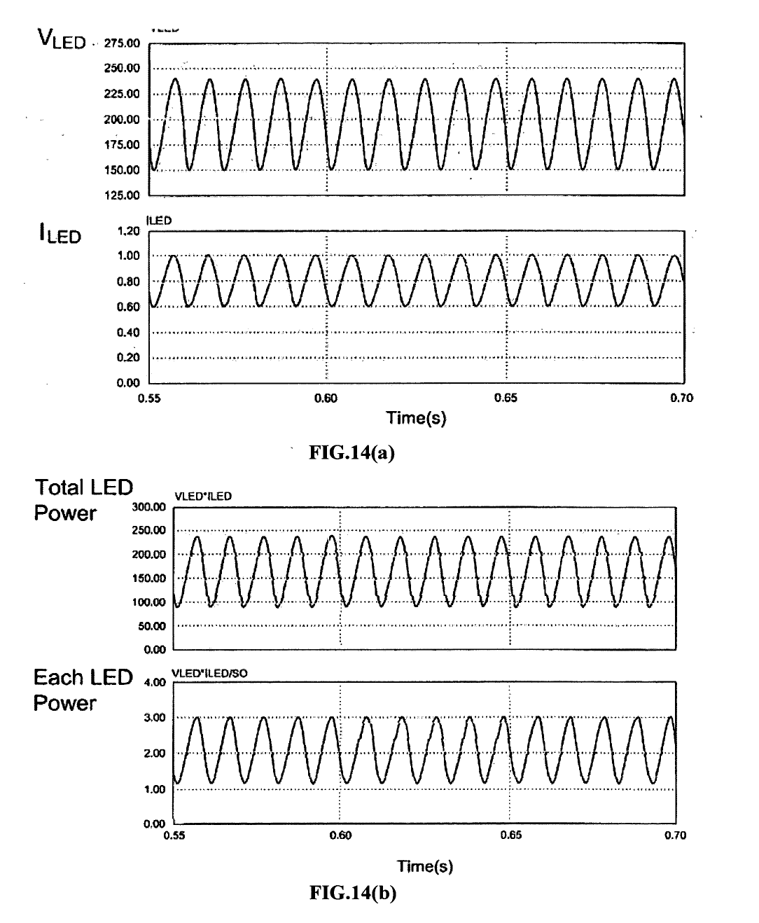

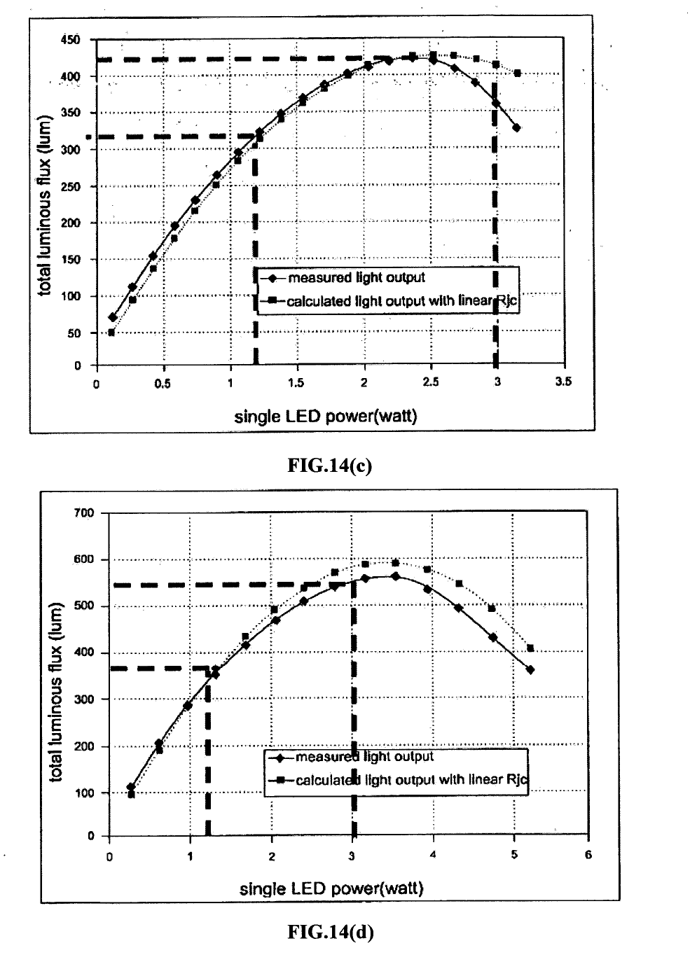

In order to illustrate this aspect of the present invention, the passive circuit of FIG. 12 is used to drive a series of 3 W LEDs. In the simulation, three diodes are used while the rest of the diodes are represented as an equivalent resistor as explained previously. FIG. 13(a) shows the simulated input voltage and current of the entire system. It can be seen that the input current waveform is not a sharp pulse (as would be expected from a diode bridge with an output capacitor) and the power factor has therefore been improved. FIG. 13(b) shows the input power of the system. FIG. 14(a) shows the simulated voltage and current of the LED module. The inductor is designed so that the LED rated current of 1 A (for the 3 W LED devices) is not exceeded in this example. Despite the pulsating input power, the reduction of the voltage fluctuation due to the use of the valley-fill circuit and the filtering effect of the inductor have smoothed the load current considerably. FIG. 14(b) shows the total LED power and individual LED power. It can be seen that the power variation is within 1.2 W to 3 W (i.e. 60%) in this example. This simulation study confirms that a passive circuit without electrolytic capacitors can be designed to provide a current source with controlled current ripple for a LED system with input power factor correction. The circuits above can be incorporated into lighting systems with a fully passive ballast. The circuits can also be incorporated into a lighting system with an active or electronic ballast, which is not explicitly shown in the figures, but can be done in the known manner.

This per-unit result of LED power in FIG. 14 can be interpreted with typical LED systems with different thermal designs. For example, it has been shown that the luminous flux-LED power curves depend on the thermal resistance of the heatsinks. FIG. 14(c) and FIG. 14(d) show typical curves for LED systems using two different heatsinks for eight 3 W LEDs. The heatsink used for FIG. 14(c) is smaller than that for FIG. 14(d). For the example in FIG. 14(c), a 60% variation from 1.2 W to 3 W for each device will lead to about 24% of light variation. For the example of FIG. 14(d), a 60% variation of LED power leads to 30% of light variation.

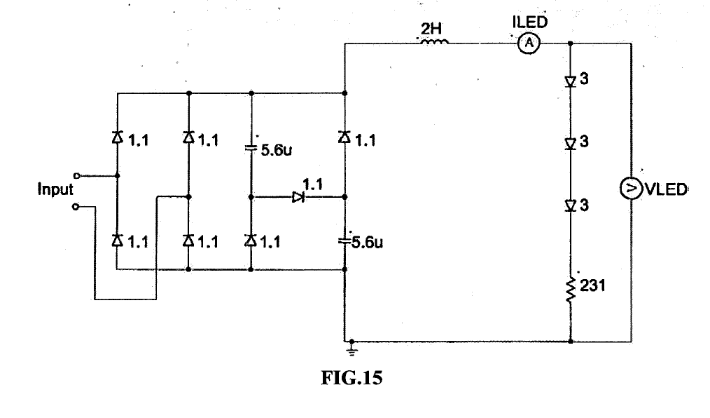

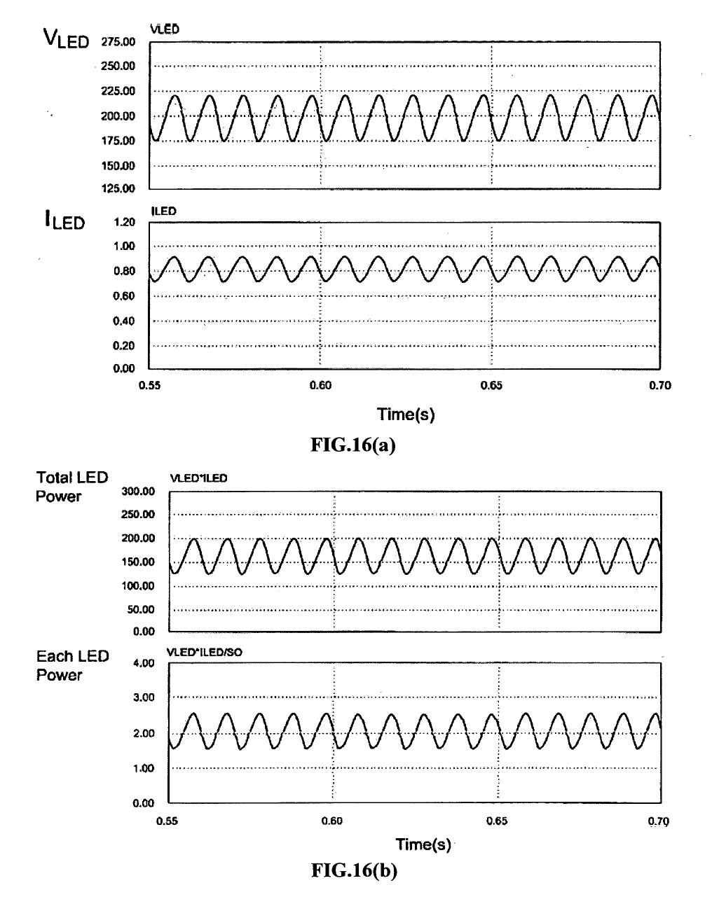

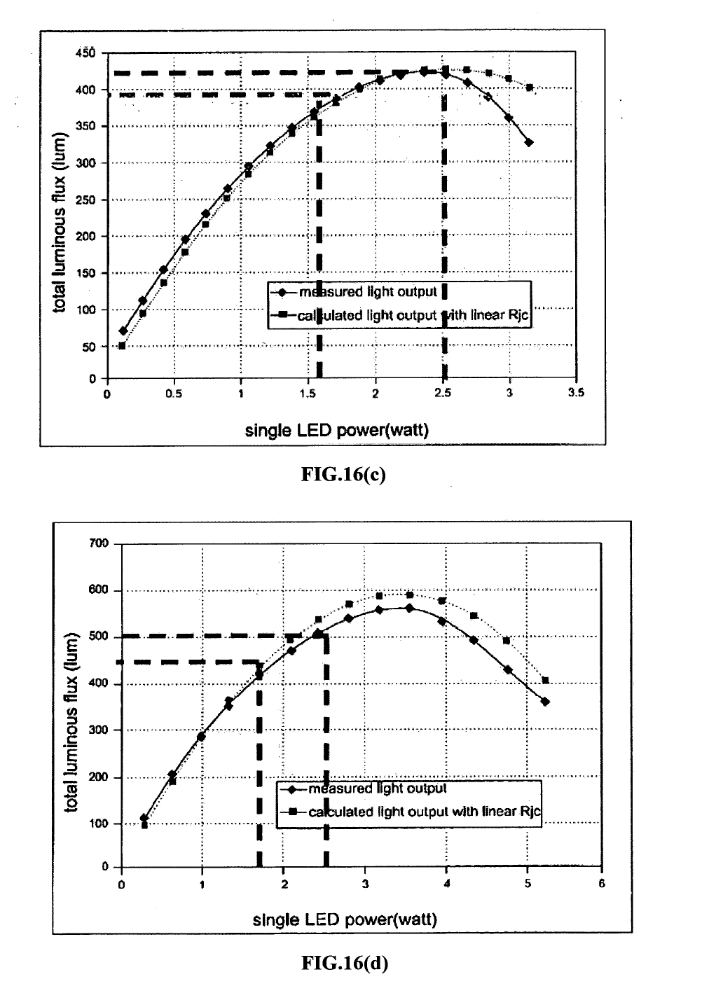

However, it is important to note that the choice of inductance of the inductor can control the current ripple and therefore the LED power variation. If the inductance L is increased from 1 H to 2 H (FIG. 15), the simulated LED voltage and current waveforms are plotted in FIG. 16(a). The corresponding total LED power and individual LED power are included in FIG. 16(b).

It can be seen that, with L increased to 2 H, the power variation (from 1.6 W to 2.5 W) is 36%. If the same power variation is applied to the two examples in reference Hui et al [Hui S. Y. R. and Qin Y. X., “General photo-electro-thermal theory for light-emitting diodes (LED) systems”, IEEE Applied Power Electronics Conference, February 2009, Washington D.C., USA, paper 16.2], FIG. 16(c) and FIG. 16(d) show that the variation in the luminous flux is approximately 7% and 12%, respectively. It is envisaged that human eyes are not sensitive to such small changes of luminous flux variation.

It can be seen that a large inductance can reduce the current ripple and LED power variation. The choice of L depends also on the core loss and copper loss in the inductor. The overall design therefore relies on the thermal design as explained in Hui et al and the choice of L so that the operating range can be restricted to the region of the luminous flux-LED power curve where the slope of the curve is small.

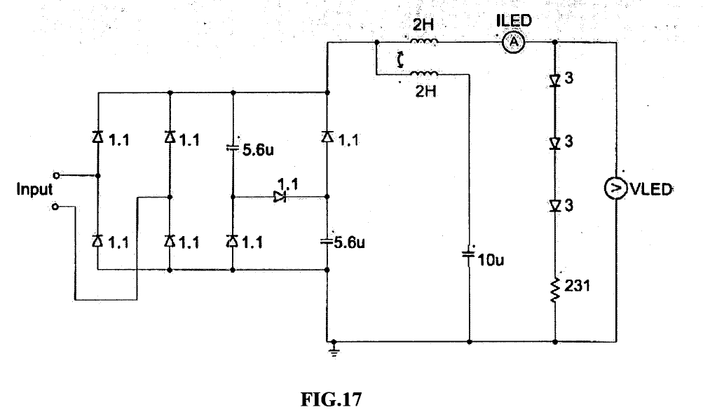

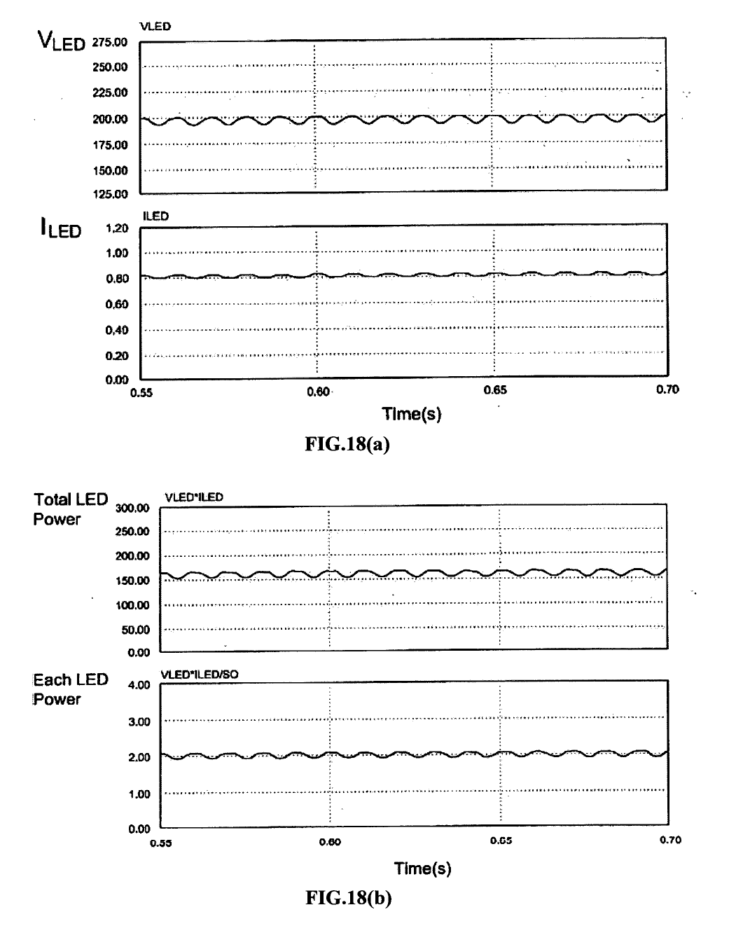

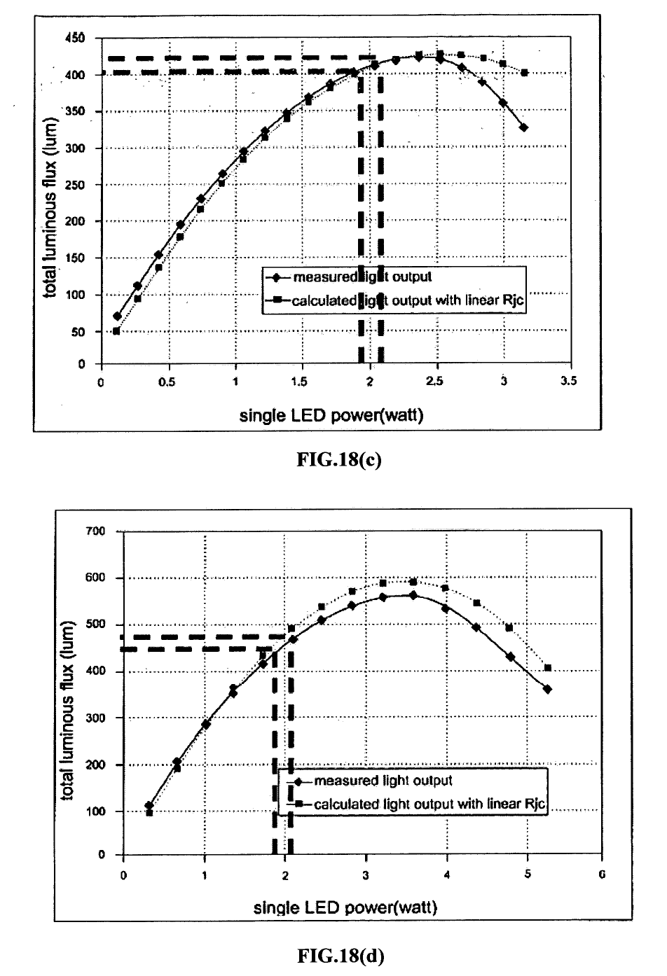

An effective method to further reduce the current ripple and thus LED power variation and light variation is to replace the inductor in FIG. 12 and FIG. 15 with a current-ripple cancellation means in the form of a coupled inductor and a capacitor as shown in FIG. 17. FIG. 18(a) and FIG. 18(b) show the electrical measurements of the system. It can be seen the variations in the LED current ripple and power have been greatly reduced. The power variation is only within 0.2 W (from 1.9 W to 2.1 W). This 9% power variation will lead to less than 4% of light variation in the two examples as shown in FIG. 18(c) and FIG. 18(d).

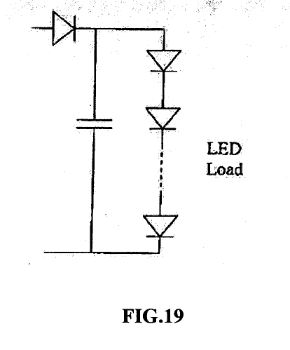

It should also be noted that it may be desirable to provide a diode-capacitor clamp that can be added to each LED string to provide a current path for the inductor current in case some of the LED devices fail. An example of such a possibility is shown in FIG. 19.

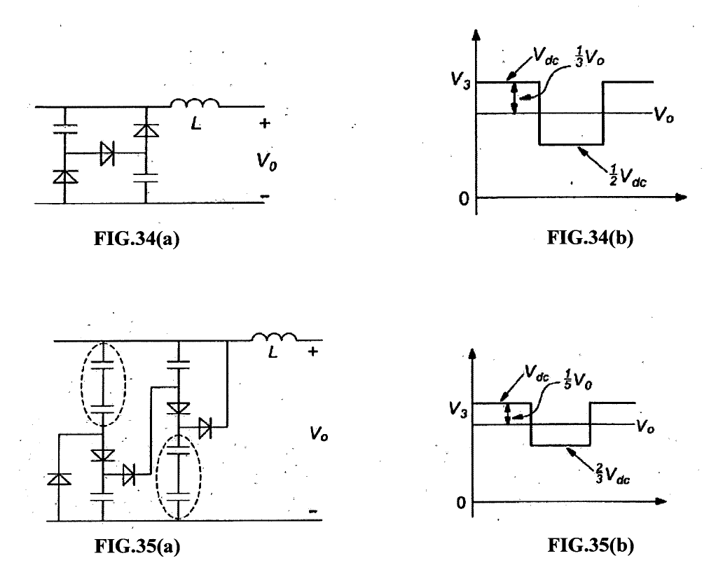

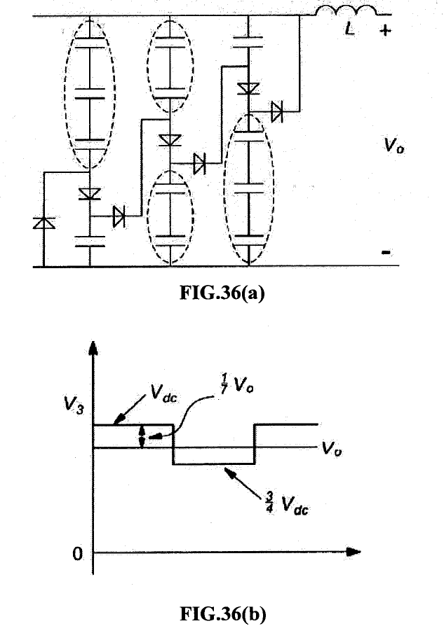

FIGS. 34(a), 34(b), 35(a), 35(b), 36(a) and 36(b) show further embodiments of the valley-fill circuit utilized in the present invention. These embodiments allow further reductions in the voltage ripple in the output voltage V₃ in order to reduce the size of the output inductor L.

From the above it will be seen that in preferred embodiments of the present invention there is proposed the use of a passive power correction circuit such as the valley-fill circuit to reduce the voltage ripple feeding the inductor (or coupled inductor with a capacitor in the form of current ripple cancellation circuit) and the LED modules in order to (i) reduce the current ripple and thus the power variation in the LEDs and (ii) to improve the input power factor. The allowance of some current and power variation in the LEDs within the region of the luminous flux-LED power curve where the slope of the curve is small will lead to only a small variation of the luminous flux from the LED system. The inductance of the inductor or coupled inductor in the form of a current ripple cancellation circuit can be used to further limit the power variation of the LED system. All of these features can apply to lighting systems with active or electronic ballasts, or fully passive ballasts.

By using a suitable thermal design the power variation range of the LED load can be designed to fall within the region of the luminous flux-LED power curve where the slope is small and the luminous flux is maximum or near maximum.

As a consequence of the requirement of only small capacitance in the proposed system, electrolytic capacitors can be eliminated from this design. Since the circuit consists of more passive and robust components (such as power diodes, non-electrolytic capacitors and inductors), it features low-cost, high robustness and reliability.

One possible issue, however, is that the above-described circuits assume a reasonably constant input voltage which may not necessarily be true. In countries where the AC mains supply is unreliable or in any other situation where there may be AC mains voltage fluctuation for whatever reason, there could be a significant variation in the LED power for a given nominal AC input voltage. In preferred embodiments of the invention therefore it may be preferable to provide a means for controlling the power sensitivity of the load against AC voltage fluctuation.

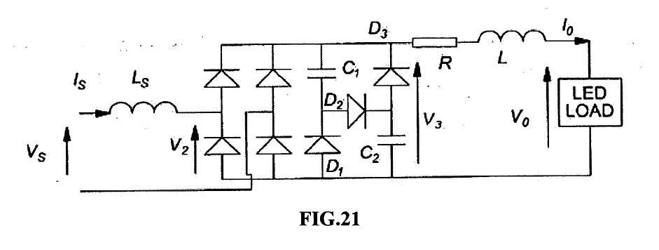

FIG. 21 shows one example of a circuit provided with means for controlling the power sensitivity of the load against AC voltage fluctuation. In this example, a ballast for an LED system is shown provided with a diode rectifier, a valley-fill circuit for reducing the voltage ripple of the rectified DC power, and a filter inductor L for generating a current source provided to the LED load. It will be understood that as described above the inductor L could instead by replaced by a current ripple reduction circuit comprising a coupled inductor with a capacitor. In this circuit an input inductor Lₛ is provided in series between the AC supply Vₛ and the diode rectifier which as will be explained below provides the necessary power sensitivity control. Again, the circuit can be incorporated in fully passive systems, or in active systems, in which case the active components are not explicitly shown in the figure, but are incorporated in the usual manner.

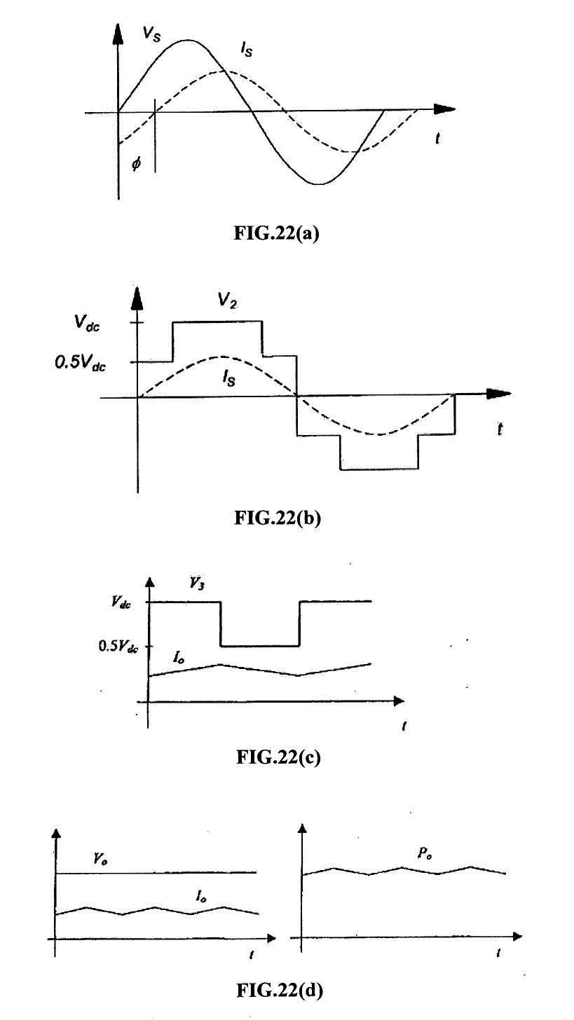

FIGS. 22(a)-(d) show the idealized waveforms of the proposed AC-DC current source circuit for LED loads. In particular: FIG. 22(a) shows idealized waveforms of input AC mains voltage and current (with a phase shift (Φ) between Vₛ and Iₛ); FIG. 22(b) shows idealized waveforms of input voltage V₂ and current Iₛ of the diode rectifier (with V₂ and Iₛ in phase); FIG. 22(c) shows idealized waveforms of output voltage V₃ and current Iₒ of the valley-fill circuit (with V₃ a rectified version of V₂); and FIG. 22(d) shows idealized waveforms of voltage across LED load (Vₒ), output load current (Iₒ) and the output load power (Pₒ).

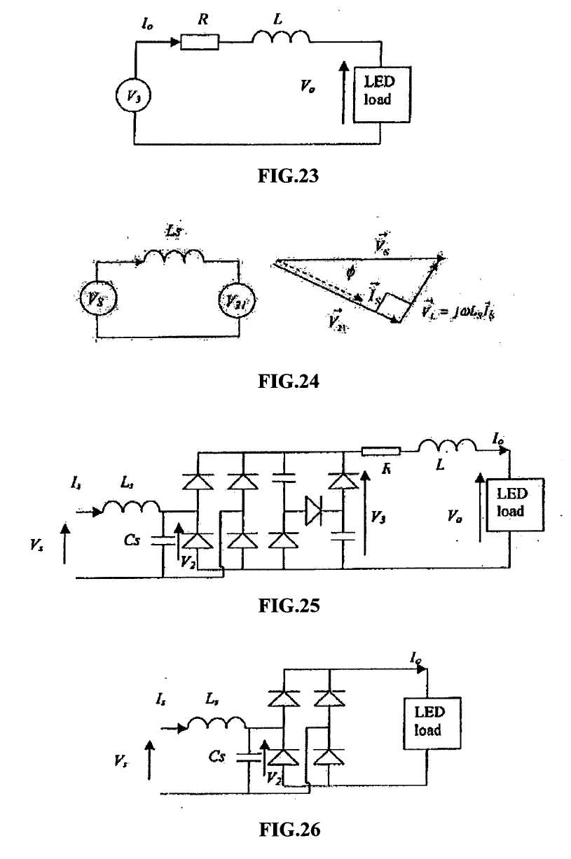

An analysis of this circuit can start from the load side by considering the equivalent circuit as shown in FIG. 23 where the inductor winding resistance is shown as R and the total LED load voltage drop V₀ is considered to be constant.

From FIG. 23, the average output current Īₒ can be expressed as:

$${\overline{I}}_{o} = \frac{{\overline{V}}_{3} - {V}_{o}}{R} \qquad ( 1 )$$

where V̅₃ is the average voltage of V₃.

From the waveform of V₃ in FIG. 22(c),

V̅₃=3/4V_{dc} (2)

V_{dc}=4/3 V̅=4/3(Vₒ+ĪₒR) (3)

It should be noted that the total voltage drop of the LED load is approximated as a constant Vₒ. Therefore, V_{dc} does not change significantly if Īₒ does not change significantly. In general, Vₒ is much bigger than ĪₒR. Thus V_{dc} is close to 1.33 Vₒ. The next issue is to find out a way to reduce the change of Iₒ due to fluctuation in the input mains voltage.

By the law of conservation of energy, input power is equal to the power entering the diode bridge, assuming that the input inductor Lₛ has negligible resistance. Also note that V₂₁ and I_{S} are in phase as shown in FIG. 22(b).

V_{S}I_{S} cos Φ=V₂₁I_{S} (4)

where V₂₁ is the fundamental component of V₂.

Similarly, the input power is also equal to the output power of the valley-fill circuit, assuming that the power loss in the diode rectifier and valley-fill circuit is negligible.

V_{S}I_{S} cos Φ= V̅₃Īₒ=3/4V_{dc}Īₒ²R+ĪₒVₒ (5)

If the inductor winding resistance is negligible, R=0, leading to

Vₒ=3/4V_{dc} (6)

Using Fourier analysis on the waveform of V₂, the fundamental component V₂₁ of V₂ can be determined as:

$${V}_{21} = \frac{( 2 + \sqrt{2} ) {V}_{d c}}{π} sin ( ω t - φ ) = 1.086 \cdot {V}_{d c} sin ( ω t - φ ) \qquad ( 7 a )$$

The root-mean-square value of V₂₁ is therefore

$${V}_{21 \_ r m s} = \frac{1.086}{\sqrt{2}} \cdot {V}_{d c} = 0.77 \cdot {V}_{d c} \qquad ( 7 b )$$

Dividing (4) by (5) to relate V₂₁ and V_{dc}, and using (7b), one can relate Iₛ and Īₒ.

0.77 V_{dc}I_{S}=0.75 V_{dc}Īₒ [symbol] I_{S}=0.9740Īₒ (8)

Now consider the equivalent circuit and the vectorial relationship between Vₛ and V₂₁ as shown in FIG. 24.

From FIG. 24

$$\begin{matrix}{V}_{S}^{2} = {V}_{21}^{2} + {( ω {L}_{S} {I}_{s} )}^{2} \\ and & ( 9 ) \\ {\vec{I}}_{s} = \frac{{\vec{V}}_{s} - {\vec{V}}_{21}}{j ω {L}_{s}} & ( 10 )\end{matrix}$$

From (7a), it can be seen that V₂₁ depends on V_{dc}, which is approximately close to 1.33 Vₒ (approximated as a constant value). With the help of (8),

$${\overline{I}}_{o} = \frac{{V}_{S} - {V}_{21}}{0.974 \cdot ω {L}_{S}} \qquad ( 11 )$$

Differentiating (11) will lead to

$$Δ {\overline{I}}_{o} = \frac{Δ {V}_{S}}{0.974 \cdot ω {L}_{S}} \qquad ( 12 )$$

Equation (12) is the important equation which shows that the input inductance Ls can be used to reduce the change of average output load current ΔĪₒ for a given change in the input AC mains voltage ΔV_{S}. Take an example. For an AC mains of 50 Hz, the angular frequency ω is equal to 100 π, that is 314.16. For an Ls of 1 H, the effect of input voltage fluctuation on the output average current will be reduced by 314.16 times as shown in (12). For an Ls of 2 H, the reduction will be 618 times. For this sensitivity control to be effective, the size of the input inductor Ls has to be reasonably large (typically near to or in the order of Henry).

In order to provide a conducting path for the inductor current in Ls in case there is any problem in other part of the circuit which may create a discontinuation of current, a capacitor Cs can be placed to the second end of the input inductor as shown in FIG. 25. This LsCs arrangement will also play the additional role of input filter. But the main purpose of using a “large” Ls here is to reduce the sensitivity of the output load current (and thus output load power) of the proposed circuit to input voltage fluctuation.

In order to relate Īₒ with Vs, we start with modifying (9) with the help of (7b) and (8) gives:

Vₛ²=(0.77V_{dc})²+[ωL_{S}(640.974Īₒ)]² (13)

Using (6), (13) becomes:

V_{S}²=[(0.77(4/3)Vₒ]²+[ωL_{S}(0.974Īₒ)]² (14)

Solving (14) gives:

$${\overline{I}}_{o} = \frac{\sqrt{{V}_{s}^{2} - {( 1.072 \cdot {V}_{o} )}^{2}}}{0.974 \cdot ω {L}_{s}} \qquad ( 15 )$$

Note that Vₒ can be determined from the number of LED devices in the LED strings. If Ls is chosen, then (15) provides the relationship between the average output current and the input ac mains voltage.

The LED load power is therefore:

$${\overline{P}}_{o} = {V}_{o} \cdot \frac{\sqrt{{V}_{s}^{2} - {( 1.072 \cdot {V}_{o} )}^{2}}}{0.974 \cdot ω {L}_{s}}$$

From the above it can be seen that by providing an input inductor in series between the AC supply voltage and the diode rectifier the sensitivity of the LED power to fluctuation in the AC supply voltage can be reduced.

Indeed the provision of an input inductor in series between the AC supply voltage and the diode rectifier may have useful applications as a means for limiting variations in the power of the LED load in circuits that do not include voltage ripple reduction. FIG. 26 shows an example of such a circuit where the input inductor Lₛ is provided in series between the AC supply voltage Vₛ and a diode rectifier the output of which is provided directly to the load. As with the circuit of FIG. 25 a capacitor Cₛ may be provided in parallel between the input inductor and the diode rectifier to provide a conducting path in the event of any short-circuit or other problem in another part of the circuit, and also to provide a filtering function.

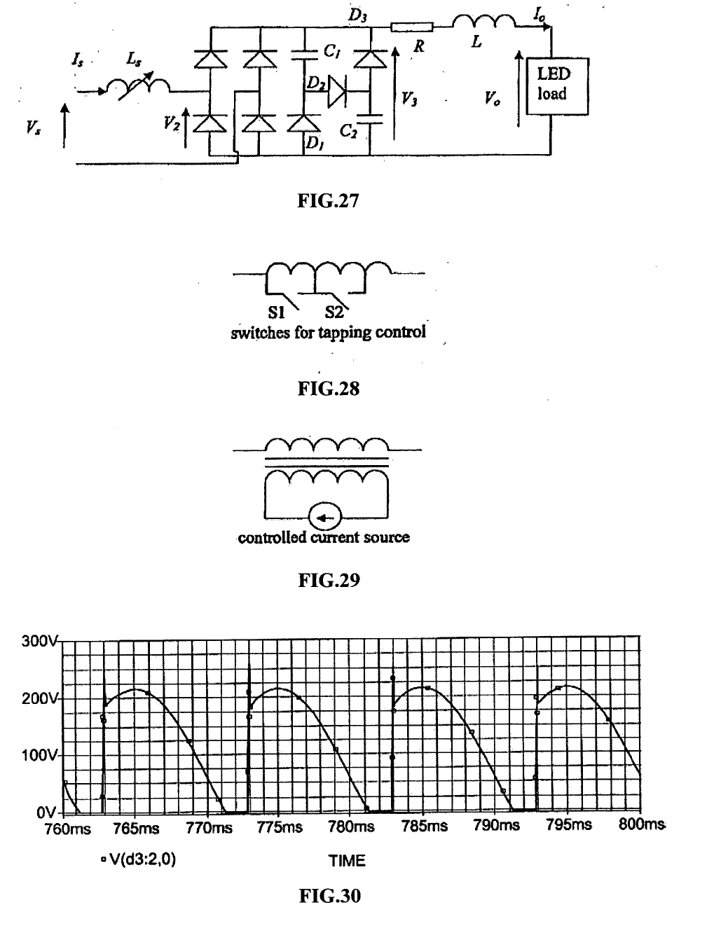

In another embodiment, the lighting system described above can become a dimmable system by using a variable input inductor Lₛ, as shown in FIG. 27. As explained previously, the use of the input inductor of a reasonably large size is to reduce the LED power sensitivity against input voltage variation. The relationship of the variation of the output current (which affects the LED power) with the input voltage variation has been shown as:

$$Δ {\overline{I}}_{o} = \frac{Δ {V}_{S}}{0.974 \cdot ω {L}_{S}}$$

The output dc current can be expressed as:

$${\overline{I}}_{o} = \frac{{V}_{S} - {V}_{21}}{0.974 \cdot ω {L}_{S}}$$

This equation means that the size of the input inductor can affect the power of the LED load. If the inductance of the input inductor Ls can be changed, a dimming function becomes possible. By using a variable inductor Ls as shown in FIG. 27, the power control of the LED load can be achieved.

The variable inductor can be implemented in various forms. For example, FIG. 28 shows an inductor with tapping control. By controlling the switch or switches, labeled as S1 and S2 in the present embodiment, to determine the number of turns in the inductor, the inductance value can be controlled. FIG. 29 shows another implementation of a variable inductor using a DC current in an auxiliary winding to alter the magnetic property (such as saturation level) of the core in order to vary the inductance value.

A further aspect of the invention refers more generally to valley-fill circuits used in reducing the DC output voltage ripple and/or current ripple in AC-DC power conversion. Based on the ratio of the capacitors used in the valley-fill circuits, the output voltage ripple can be further controlled and reduced. Thus, it can be used to provide a DC voltage source with an even more reduced voltage variation than that, for example, described above. Further, if an inductor is connected to the output of the valley-fill circuit in order to turn the voltage source into a current source, a current source with a further reduced current ripple can also be generated.

This further aspect of the present invention is particularly suitable to a variety of applications in which a fairly constant output current source is required. Thus, although this aspect of the invention will be described with reference to drivers for LED loads for general lighting applications such as those described above, this aspect of the invention can be applied more generally.

Valley-fill circuits have been proposed as passive methods (without active power switches) for input power factor corrections in AC-DC power conversion circuits and have been adopted in low-cost applications such as electronic ballasts and AC-DC converters. Modified versions of valley-fill circuits have also been suggested for power factor correction. Two common features shared by these valley-fill applications are (i) the valley-fill circuits are used primarily for shaping the input current in the AC-DC power conversion circuit for improving the power factor and (ii) use capacitors of equal capacitance value in the individual circuits.

As described above, valley-fill circuits are used for reducing the output DC voltage ripple or variation so that a fairly constant current source can be generated with the help of a filter inductor. One preferred embodiment of such a circuit is shown in FIG. 21, which as mentioned above can be incorporated into lighting systems with active or passive ballasts. In traditional applications of valley-fill circuits, the two capacitors C1 and C2 are of the same capacitance value. This will allow the output voltage to be smaller than that of a diode bridge, i.e. the output voltage ripple can be reduced by about 50%.

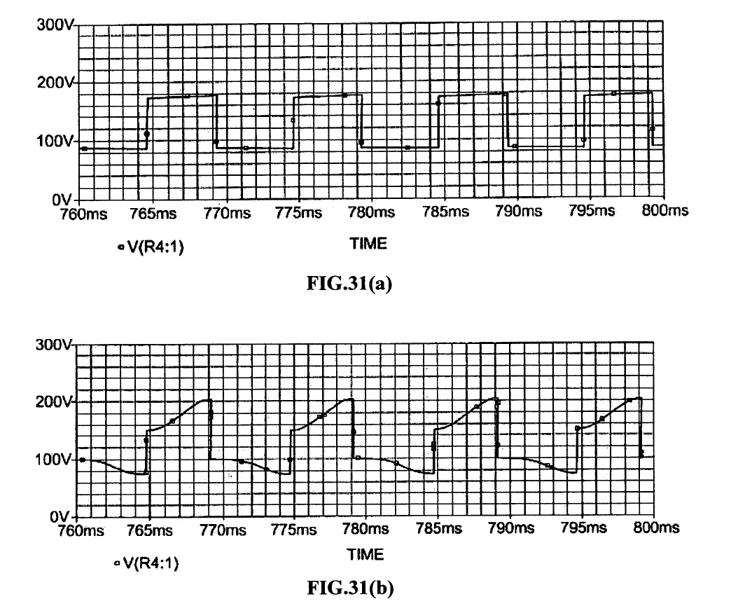

If the valley-fill circuit in FIG. 21 is not used, the front-end diode rectifier provides a rectified output voltage as shown in FIG. 30. It can be seen that the rectified DC voltage peaks at the maximum value of the input sinusoidal voltage and then drops to zero. However, when the valley-fill circuit is provided with C1=C2=220 μF, the output DC voltage feeding the filter inductor L and LED load has a much reduced voltage ripple as displayed in FIG. 31(a). In this case, the maximum voltage is close to 180V and minimum voltage is close to 90V.

It should be noted that smaller capacitors such as C1=C2=22 μF can also be used. For capacitance of this low magnitude, electrolytic capacitors which have short lifetimes are not needed. FIG. 31(b) shows the output DC voltage of the valley-fill circuit with these smaller capacitors. Also voltage charging and discharging in the capacitors becomes obvious, as shown in FIG. 31(b), but the average voltage is close to that in FIG. 31(a).

In the cases of FIG. 31(a) and FIG. 31(b), the output DC voltage ripple is about 50% of the maximum value. This is a typical feature of valley-fill circuits where C1 and C2 are identical. When the voltage V₂ is at its peak, the output voltage of the valley-fill circuit, which is clamped by the voltage across the LED load, will reach its maximum value. The rectified input current charges the two identical capacitors C1 and C2 through the diode D₂ equally and hence the two capacitor voltages are equal at this moment. Note that this voltage for C2 (half of the maximum DC voltage) is the maximum voltage of C2. Therefore, only full maximum voltage or half maximum voltage levels appear in the output voltage of the valley-fill circuit if C1 and C2 are large enough and of equal capacitance. Note that the lower DC voltage is actually the voltage across C2. With a voltage ripple reduced to 50%, the size of the filter inductor L can be reduced too.

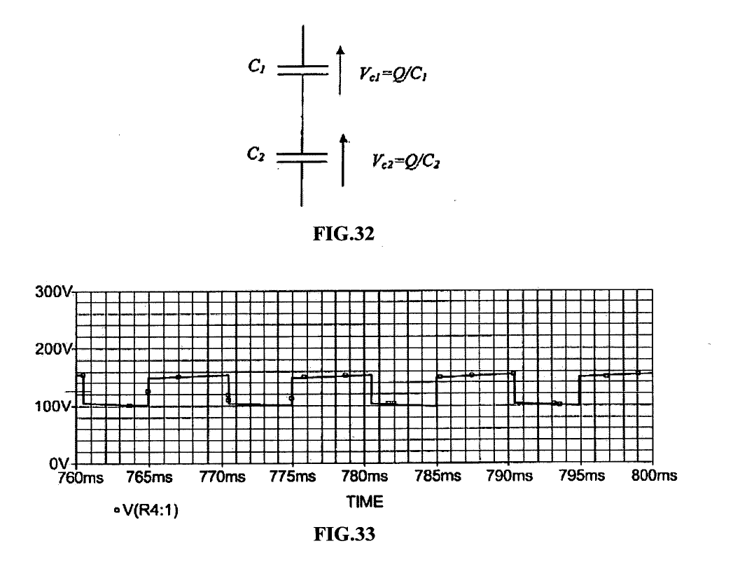

However, the output DC voltage of the valley-fill circuit can be further reduced so as to further reduce the output ripple in the DC current and/or the size of the filter inductor. For capacitors connected in series, it is well known that the voltage of across each capacitor depends on the size of the capacitance. FIG. 32 shows one example of two capacitors connected in series. Note that the current flow into this series circuit branch is the same in the two capacitors regardless of their capacitance. That is to say, the capacitors have the same amount of charge for a given series current flow. The voltage across each capacitor is inversely proportional to the size of the capacitor.

In order to increase the lower DC voltage level (i.e. voltage across C2), one can select the capacitance of C2 to be smaller than that of C1 (i.e. C1>C2). This rule ensures that the voltage across C2 is higher than 50% of the maximum DC voltage. In order to confirm this concept, C1 and C2 are changed to 6600 μF and 330 μF, respectively. FIG. 33 shows the resulting output DC voltage of the valley-fill circuit if this is done. It can be seen that the voltage ripple is now reduced to about 30%.

Thus, specifying C1>C2 further reduces the output voltage ripple in the valley-fill circuit so as to reduce the ripple in the output inductor current and/or the size of the filter inductor.

It will be noted that any capacitors, including electrolytic capacitors, can be used. However, non-electrolytic capacitors are preferred since these lead to longer lifetimes and higher reliability.

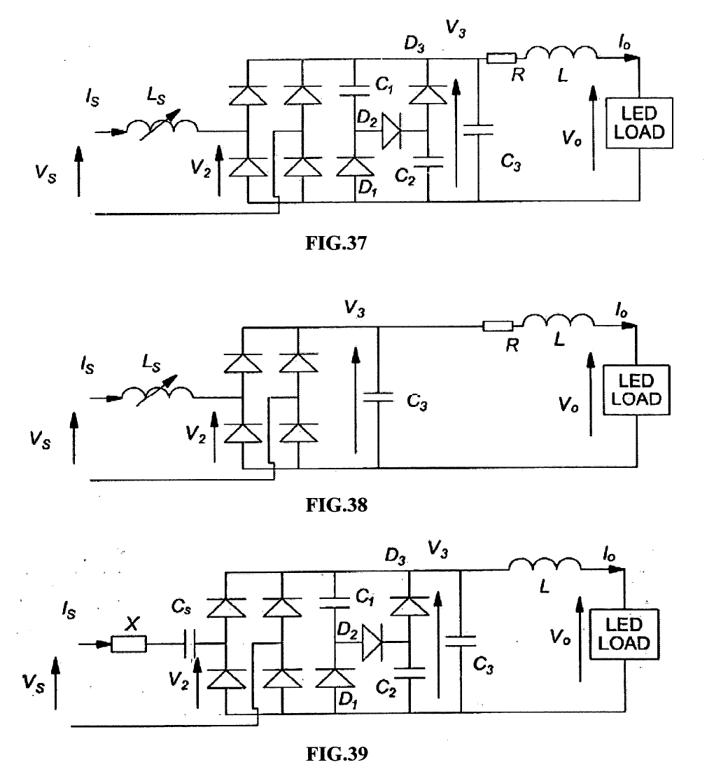

Further reductions of the voltage ripple in the output voltage V₃ can be achieved by having a parallel capacitor C₃ across the output of the valley-fill circuit. This allows for further reductions in the size of the output inductor L, which in turn, reduces cost. An embodiment of the invention using such a parallel capacitor C₃ is shown in FIG. 37.

With particular reference to FIG. 37, Ls is the inductor that is used to control the power flow into the LED circuit. It can be a linear inductor or a variable inductor. The diode bridge and the valley-fill circuit rectify the input ac voltage Vs into a dc voltage with a reduced voltage ripple (V₃). The output filter inductor L (with its winding resistance R) is used to reduce the output current ripple Iₒ.

Although the parallel capacitor C₃ has been described as being connected across the output of the valley-fill circuit shown in FIG. 37, the capacitor C₃ can be similarly applied to other variants of the valley-fill circuit. Furthermore, although C₃ can be of the electrolytic type, it is preferred that C₃ is of the non-electrolytic type, which typically have a longer lifetime.

Instead of utilizing a valley-fill circuit as described above, a simpler circuit having a rectification circuit with an output capacitor can be used. No valley-fill circuit is required in this embodiment. Since the input inductor Ls is large enough to provide input current filtering, the input current is primarily sinusoidal and has low current harmonic content. The input power factor can be improved by using standard techniques, such as using a parallel capacitor across the ac mains.

An example of this embodiment is shown in FIG. 38, which again can be incorporated into lighting systems with active or passive ballasts. In particular, FIG. 38 shows a circuit with a rectification circuit in the form of a basic diode bridge and an output capacitor C₃ connected across the output of the diode bridge. The output-current-filtering inductor L is still needed. R represents the winding resistance of L. The circuit of FIG. 38 does not require a valley-fill circuit.

However, like the previously described embodiments, the circuit of the present embodiment requires an input inductor Lₛ to control the power flow to the LED load. Part of the analysis detailed above for the input inductor Lₛ, in relation to the other embodiments described above, remains that same. Furthermore, Lₛ can be either a linear inductor or a variable inductor.

The analysis provided above in relation to the other embodiments is repeated below in the context of the presently described embodiment.

Firstly, consider the equivalent circuit and the vectorial relationship between Vₛ and V₂₁ as shown in FIG. 24.

From FIG. 24, we have

$$\begin{matrix}{V}_{S}^{2} = {V}_{21}^{2} + {( ω {L}_{S} {I}_{s} )}^{2} \\ \text{and} & ( 9 ) \\ {\vec{I}}_{s} = \frac{{\vec{V}}_{s} - {\vec{V}}_{21}}{j ω {L}_{s}} & ( 10 )\end{matrix}$$

From (6), it can be seen that V₂₁ depends on V_{dc}, which is approximately close to Vₒ (approximated as a constant value). With the help of (8),

$${\overline{I}}_{o} = \frac{{V}_{S} - {V}_{21}}{0.974 \cdot ω {L}_{S }} \qquad ( 11 )$$

Differentiating (11) will lead to

$$Δ {\overline{I}}_{o} = \frac{Δ {V}_{S}}{0.974 \cdot ω {L}_{S}} \qquad ( 12 )$$

Equation (12) is the important equation which shows that the input inductance Ls can be used to reduce the change of average output load current ΔĪₒ for a given change in the input ac mains voltage ΔV_{S}. Take an example. For an ac mains of 50 Hz, the angular frequency ω is equal to 100 π, that is 314.16. For an Ls of 1 H, the effect of input voltage fluctuation on the output average current will be reduced by 314.16 times as shown in (12). For an Ls of 2 H, the reduction will be 618 times. For this sensitivity control to be effective, the size of the input inductor Ls has to be reasonably large (typically near to or in the order of Henry).

In order to provide a conducting path for the inductor current in Ls in case there is any problem in other part of the circuit which may create a discontinuation of current, a capacitor Cs can be placed to the second end of the input inductor, similar to the arrangement shown in FIG. 25. This LsCs arrangement will also play the additional role of input filter. But the main purpose of using a “large” Ls here is to reduce the sensitivity of the output load current (and thus output load power) of the proposed circuit to input voltage fluctuation.

The circuit shown in FIG. 41 is another example of how to reduce the power sensitivity. In this circuit, which can be incorporated into systems with active or passive ballasts, a capacitor Cₛ and a winding are introduced. As shown in FIG. 42, the phase difference between I_{Ls} and −I_{Cs}, is relatively small (which can also be found from the experimental existing waveforms), and as an approximation, the two currents can be considered to be in phase with each other.

When the input voltage V_{S} increases, the current I_{Cs} increases accordingly, as well as the induced flux φ₂. Since φ₁ and φ₂ are in phase, the equivalent inductor Lₛ increases, leading to reduced power sensitivity.

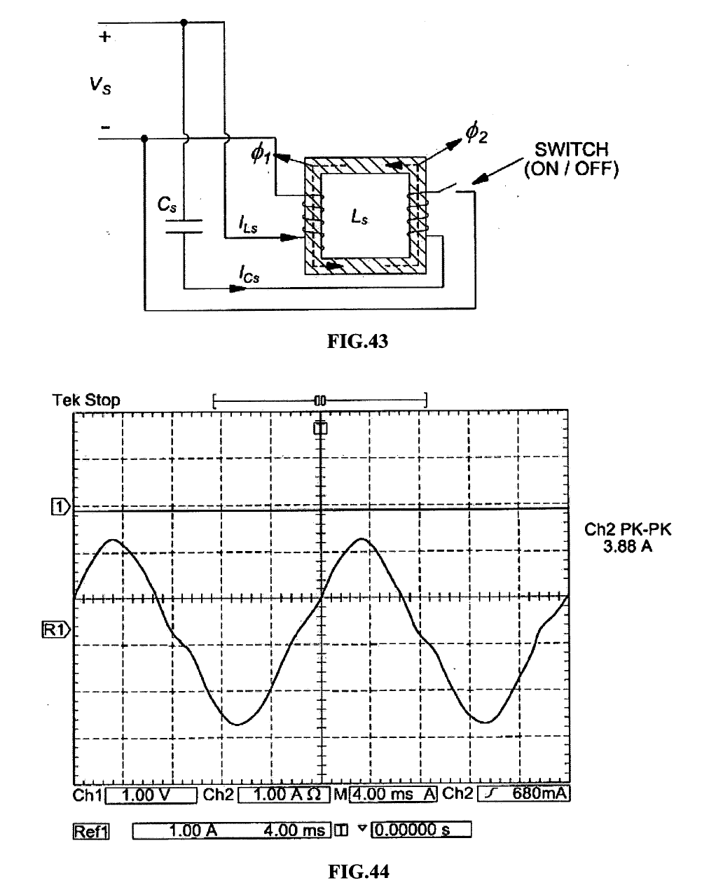

The above theory can be verified by the simple circuit shown in FIG. 43, for which the experimental results are shown in FIG. 44. It can be seen that under the same input voltage, when the switch is on, the input current I_{Ls} is reduced (that is, the peak-to-peak value is reduced from 4.12 A to 3.88 A), which is equivalent to the inductor Lₛ being enlarged. It will be appreciated that there are other embodiments that can utilize the features shown in FIG. 41, such as those that further include a valley-fill circuit or where the output capacitor C₁ connected across the diode bridge output is replaced by a valley-fill circuit, both of which have been described above.

In some of the embodiments described above an input inductor Lₛ is used to limit the power flow into the LED load and to filter the input current. The use of an input inductor Lₛ provides robustness for the LED driver against transients, such as lightning and large voltage transients in the ac mains, since an inductor is a good low-pass filter. So the use of an input inductor in the LED driver described above is particularly suitable for outdoor applications. However, for some indoor applications, the size of the LED driver may be a concern.

One way to reduce the size of the LED driver is to replace the input inductor Lₛ with an input capacitor Cₛ as shown in FIG. 39. In order to reduce the inrush current when the LED driver is turned on, an anti-current-surge component (X) can be connected in series with Cₛ as shown in FIG. 39. This LED driver is suitable for applications where the ac mains voltage is fairly stable, such as indoor applications. The anti-current-surge component (X) can be a small inductor or a temperature-dependent resistor (for example, an NTC thermistor with high resistance when cold and low resistance when hot).

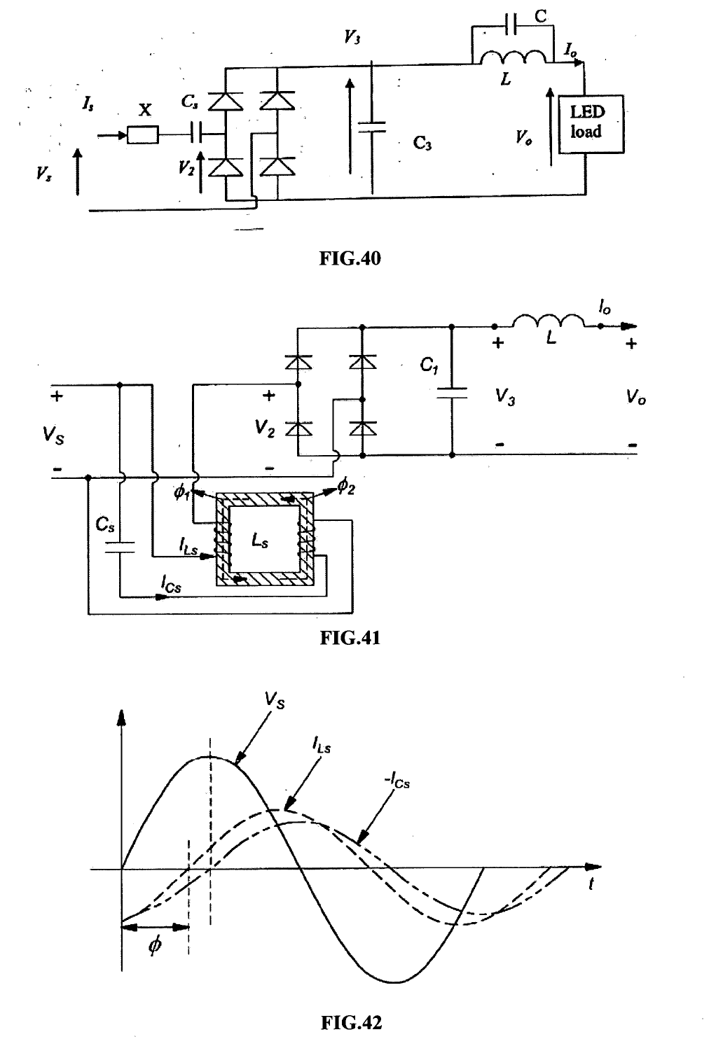

A second way to further reduce the size of the system in FIG. 39 is to add a capacitor C across the output inductor L, as shown in FIG. 40. By tuning the LC values as a tuned filter at the ripple frequency, which is 100 Hz for 50 Hz ac mains and 120 Hz for 60 Hz ac mains, the size of the output inductor L can be reduced.

It will be easily appreciated that both of these aforementioned ways of further reducing the size of the system apply individually or together to the embodiments described above and other embodiments. For example, it will be easily appreciated that the valley-fill circuit in FIG. 39 can be replaced by other variants of the valley-fill circuit, with or without the output capacitor C₃. The valley-fill circuit of FIG. 39 can also be replaced by simpler circuits such as one with just the output capacitor C₃. Indeed, the embodiment of FIG. 40 includes the output capacitor C3 instead of the valley-fill circuit, but it will be easily appreciated that variants of the embodiment of FIG. 40 can also include a valley-fill circuit instead of or in addition to the output capacitor C₃. However, it should be noted that in some embodiments, such as that specifically shown in FIG. 40, the inclusion of a valley-fill circuit in addition to the output capacitor C3 would make the valley-fill circuit redundant and therefore unnecessary to include.

As indicated, the above circuits can apply to both passive and active systems. However, with particular regard to active systems, embodiments include a single-stage AC-DC power converter or a double-stage AC-DC and DC-DC power converter to convert the ac power source into a dc one for driving the LED load. According to preferred embodiments of the invention, the LED power is allowed to vary in order to reduce the energy storage requirement of the AC-DC power converter so as to eliminate the use of high-capacity electrolytic capacitors. The AC-DC power converters could be of step-up type (such as boost converter), step-down type (such as forward converter) or step-up/down type (such as flyback converter, Cuk converter, and SEPIC converter). It should be noted that the proposed relaxation of output power control to allow a specific range of power variation in this invention enables existing switched mode power converters with the usually tight output power regulation to be easily modified without major re-design process. Simply by relaxing the output power control loop to allow the output power to fluctuate within a specific range, the energy storage requirement can be reduced and thus the need for electrolytic capacitor can be eliminated.

As an example, if the output power is tightly controlled to be constant (i.e. output power variation=0%), the peak-to-peak power variation in the energy storage buffer is ±100% of the average power (see FIG. 5(b)) and so a large capacitor is needed. If the output power is allowed to vary at ±40% of the average output power (FIG. 6(a)), the energy storage requirement and therefore the size of the storage capacitance can be reduced by 40% (FIG. 6(b)), and yet the minimum output power is 60% of the average output power, implying that the flickering effect will not be noticeable because of a relatively large and continuous luminous flux output. In practice, an output power variation up to ±50% of the average output power is acceptable without noticeable flickering even at a mains frequency of 50 Hz.

The present invention in its preferred forms provides a generalized method of eliminating the use of electrolytic capacitors in both passive (i.e. without actively controlled semiconductor switches) and active (i.e with the use of actively controlled semiconductor switches) LED drivers through a limited variation of the LED load power within a prescribed range as a means of reducing the energy storage requirements in the power conversion process and maintaining a continuous DC luminous flux component for avoiding noticeable flickering effect.

The following table provides a summary of the advantages of the present invention compared with prior systems.

In general, although the invention has been described with reference to specific examples, it will be appreciated by those skilled in the art that the invention can be embodied in many other forms. It will also be appreciated by those skilled in the art that the features of the various examples described can be combined in other combinations.

1. An LED lighting system comprising:
a driver for receiving an AC input power and generating an output power, the driver having an energy storage element for storing said AC input power as stored power when said AC input power is higher than required to generate said output power, and for delivering said stored power when said AC input power is lower than required to generate said output power; and
at least one LED receiving said output power;
wherein said driver allows said output power to vary a predetermined amount such that said at least one LED provides continuous flux as observable to the human eye, and said energy storage element has a decreased capacity requirement as said predetermined amount is increased.

2. A system as claimed in claim 1 wherein said output power has an average output power and said predetermined amount is up to a maximum of about ±50% of said average output power.

3. A system as claimed in claim 1 wherein said output power has an average output power and said predetermined amount is up to a maximum of about ±40% of said average output power.

4. A system as claimed in claim 1 wherein said output power has an average output power and the maximum difference between said AC input power and said output power is about ±50% of said average output power.

5. A system as claimed in claim 1 wherein said output power has an average output power and the maximum difference between said AC input power and said output power is about ±60% of said average output power.

6. A system as claimed in claim 1 wherein said output power is at substantially the same frequency as said AC input power.

7. A system as claimed in claim 1 wherein said driver comprises:
(a) a rectification circuit for rectifying said AC input power and generating a rectified DC power;
(b) a first circuit for reducing the voltage ripple of said rectified DC power; and
(c) a second circuit for generating said output power in the form of a current source;
said at least one LED receiving said current source as an input.

8. A system as claimed in claim 7 wherein said first circuit is a valley-fill circuit located between said rectification circuit and said second circuit.

9. A system as claimed in claim 8 wherein said valley-fill circuit includes a first capacitor and a second capacitor.

10. A system as claimed in claim 9 wherein the first and second capacitors have the same capacitance.

11. A system as claimed in claim 9 wherein the first and second capacitors have different capacitances.

12. A system as claimed in claim 8 including a parallel capacitor connected across the output of the valley-fill circuit.

13. A system as claimed in claim 8 wherein said valley-fill circuit includes a voltage-doubler.

14. A system as claimed in claim 7 wherein said second circuit comprises an inductor.

15. A system as claimed in claim 14 including a capacitor connected in parallel across the inductor.

16. A system as claimed in claim 7 wherein said second circuit is a current ripple reduction circuit.

17. A system as claimed in claim 16 wherein said current ripple reduction circuit comprises a coupled inductor with a capacitor.

18. A system as claimed in claim 7 wherein means are provided for controlling the sensitivity of the LED power to fluctuations in the voltage of the AC input power.

19. A system as claimed in claim 18 wherein said means for controlling the sensitivity of the LED power to fluctuations in the voltage of the AC input power comprises an input inductor provided in series between the AC input and the diode rectification circuit.

20. A system as claimed in claim 19 further comprising a capacitor provided in parallel between the said input inductor and the said diode rectification circuit.

21. A system as claimed in claim 19 wherein the input inductor is inductively coupled to a secondary winding connected in parallel across the AC input before the input inductor.

22. A system as claimed in claim 21 further comprising a capacitor connected in series between the secondary winding and the AC input before the input inductor.

23. A system as claimed in claim 19 wherein said input inductor is a variable inductor controllable such that the at least one LED is dimmable.

24. A system as claimed in claim 18 wherein said first circuit includes an output capacitor connected across said rectification circuit between said rectification circuit and said second circuit.

25. A system as claimed in claim 7 including an input capacitor connected in series between the AC input and the rectification circuit.

26. A system as claimed in claim 25 including an anti-surge-component connected in series with the input capacitor.

27. A system as claimed in claim 26 wherein the anti-surge-component is an inductor or a temperature-dependent resistor.

28. A system as claimed in claim 7 wherein means are provided for varying the AC input power such that the at least one LED is dimmable.

29. A system as claimed in claim 28 wherein said means for varying the AC input power comprises a variable inductor provided in series between the AC input and the diode rectification circuit.

30. A system as claimed in claim 29 wherein said variable inductor is provided with tapping control.

31. A system as claimed in claim 29 wherein said variable inductor is provided with an auxiliary winding having a current to alter a magnetic property of the core in order to vary the inductance value of said variable inductor.

32. A system as claimed in claim 1 wherein the operating and/or design parameters of said at least one LED are chosen such that said predetermined amount by which said output power is allowed to vary can be increased.

33. A system as claimed in claim 1 wherein said AC input power is provided by an AC input power source and said driver comprises:
(a) a rectification circuit for rectifying said AC input power and generating a rectified DC power; and
(b) an input inductor provided in series between said AC input power source and said rectification circuit.

34. A system as claimed in claim 33 further comprising a capacitor provided in parallel between the said input inductor and the said diode rectification circuit.

35. A system as claimed in claim 33 wherein the input inductor is inductively coupled to a secondary winding connected in parallel across the AC input power source before the input inductor.

36. A system as claimed in claim 35 further comprising a capacitor connected in series between the secondary winding and the AC input before the input inductor.

37. A system as claimed in claim 33 wherein said input inductor is a variable inductor controllable such that the LED lighting system is dimmable.

38. A system as claimed in claim 37 wherein said variable inductor is provided with tapping control.

39. A system as claimed in claim 37 wherein said variable inductor is provided with an auxiliary winding having a current to alter a magnetic property of the core in order to vary the inductance value of said variable inductor.

40. A method of operating a LED lighting system comprising the steps of:
providing an AC input power;
generating an output power for delivery to at least one LED;
storing said AC input power as stored power in an energy storage element when said AC input power is higher than required to generate said output power;
delivering said stored power from said energy storage element when said AC input power is lower than required to generate said output power; and
allowing said output power to vary such that said at least one LED provides continuous flux as observable to the human eye, and said energy storage element has a decreased capacity requirement as said predetermined amount is increased.

41. A method as claimed in claim 40 wherein said output power has an average output power and is allowed to vary up to a maximum of about ±50% of said average output power.

42. A method as claimed in claim 40 wherein said output power has an average output power and is allowed to vary up to a maximum of about ±40% of said average output power.

43. A method as claimed in claim 40 wherein said output power has an average output power and is allowed to vary such that the maximum difference between said AC input power and said output power is about ±50% of said average output power.

44. A method as claimed in claim 40 wherein said output power has an average output power and is allowed to vary such that the maximum difference between said AC input power and said output power is about ±60% of said average output power.

45. A method as claimed in claim 40 wherein said output power is generated at substantially the same frequency as said AC input power.

46. A method as claimed in claim 40 comprising the steps of:
(a) rectifying said AC input voltage to generate a rectified DC power;
(b) reducing the voltage ripple of said rectified DC power;
(c) generating said output power in the form of a current source from said voltage ripple reduced rectified DC power; and
(d) delivering said current source as an input to said at least one LED.

47. A method as claimed in claim 40 including choosing the operating and/or design parameters of said at least one LED such that the amount by which said output power is allowed to vary can be increased.

48. A method as claimed in claim 40 including choosing a thermal characteristic of said at least one said LED such that said predetermined amount by which said output power is allowed to vary can be increased.

49. A method as claimed in claim 48 wherein said thermal characteristic comprises the design of the heatsink.

50. A method as claimed in claim 48 wherein said thermal characteristic comprises the provision of forced cooling or natural cooling.

51. A method as claimed in claim 46 wherein a valley-fill circuit is used to reduce the voltage ripple of the rectified DC power.

52. A method as claimed in claim 51 wherein the valley-fill circuit is provided with a first capacitor and a second capacitor.

53. A method as claimed in claim 52 wherein the first capacitor and the second capacitor have the same capacitance.

54. A method as claimed in claim 52 wherein the first capacitor is selected with a different capacitance to the second capacitor.

55. A method as claimed in claim 51 wherein a parallel capacitor is connected across the output of the valley-fill circuit to further reduce the voltage ripple of the rectified DC power.

56. A method as claimed in claim 51 wherein said valley-fill circuit includes a voltage-doubler.

57. A method as claimed in claim 46 further comprising the step of reducing the current ripple of said current source.

58. A method as claimed in claim 57 wherein an inductor is used to reduce the current ripple.

59. A method as claimed in claim 58 wherein a capacitor is connected in parallel across the inductor.

60. A method as claimed in claim 57 wherein a coupled inductor with a capacitor is used to reduce the current ripple.

61. A method as claimed in claim 46 further comprising reducing the sensitivity of the LED power to fluctuations in the AC input voltage.

62. A method as claimed in claim 61 further comprising providing an input inductor to reduce the sensitivity of the LED power to fluctuations in the AC input voltage before rectifying the AC input voltage.

63. A method as claimed in claim 62 further comprising providing a capacitor in parallel after the said input inductor before rectifying the AC input voltage.

64. A method as claimed in claim 62 further comprising inductively coupling the input inductor to a secondary winding connected in parallel across the AC input before the input inductor.

65. A method as claimed in claim 64 wherein a capacitor is connected in series between the secondary winding and the AC input before the input inductor.

66. A method as claimed in claim 62 further comprising controllably varying the input inductor such that the at least one LED is dimmable.

67. A method as claimed in claim 61 wherein an output capacitor connected across the rectified DC power is used to reduce the voltage ripple of the rectified DC power.

68. A method as claimed in claim 46 further comprising providing an input capacitor connected in series with the AC input before rectifying the AC input voltage.

69. A method as claimed in claim 68 further comprising providing an anti-surge-component connected in series with the input capacitor.

70. A method as claimed in claim 69 wherein the anti-surge-component is provided as an inductor or a temperature-dependent resistor.

71. A method as claimed in claim 46 further comprising varying the AC input voltage such that the at least one LED is dimmable.

72. A method as claimed in claim 71 further comprising providing a variable inductor to vary the AC input voltage.

73. A method as claimed in claim 72 further comprising controlling the variable inductor with tapping control.

74. A method as claimed in claim 72 further comprising providing the variable inductor with an auxiliary winding having a current and altering a magnetic property of the core in order to vary the inductance value of said variable inductor.

75. A method as claimed in claim 40 comprising the steps of:
(a) providing an AC input to provide said AC input power;
(b) reducing the sensitivity of said output power delivered to said at least one LED to fluctuations in the voltage of said AC input power; and
(c) rectifying said AC input power and generating said output power in the form of a rectified DC power that is delivered to said at least one LED.

76. A method as claimed in claim 75 further comprising providing an input inductor to reduce the sensitivity of said output power to fluctuations in the AC input voltage before rectifying said AC input power.

77. A method as claimed in claim 76 further comprising providing a capacitor in parallel after the said input inductor before rectifying the AC input power.

78. A method as claimed in claim 76 further comprising inductively coupling the input inductor to a secondary winding connected in parallel across the AC input before the input inductor.

79. A method as claimed in claim 78 wherein a capacitor is connected in series between the secondary winding and the AC input before the input inductor.

80. A method as claimed in claim 76 wherein the input inductor is a variable inductor to vary the AC input power such that said at least one LED is dimmable.

81. A method as claimed in claim 80 further comprising controlling the variable inductor with tapping control.

82. A method as claimed in claim 80 further comprising providing the variable inductor with an auxiliary winding having a current and altering a magnetic property of the core in order to vary the inductance value of said variable inductor.

83. A system as claimed in claim 1 wherein said AC input power is provided by an AC input power source and said driver comprises:
(a) a rectification circuit for rectifying said AC input power and generating a rectified DC power; and
(b) an input capacitor provided in series between said AC input power source and said rectification circuit.

84. A system as claimed in claim 83 including an anti-surge-component connected in series with the input capacitor.

85. A system as claimed in claim 84 wherein the anti-surge-component is an inductor or a temperature-dependent resistor.

86. A method as claimed in claim 40 comprising the steps of:
(a) providing an AC input to provide said AC input power;
(b) providing an input capacitor to receive said AC input power from said AC input; and
(c) rectifying said AC input power from the input capacitor and generating said output power in the form of a rectified DC power that is delivered to said at least one LED.

87. A method as claimed in claim 86 further comprising providing an anti-surge-component connected in series with the input capacitor.

88. A method as claimed in claim 87 wherein the anti-surge-component is provided as an inductor or a temperature-dependent resistor.

89. A system as claimed in claim 1 wherein said driver is passive.

90. A system as claimed in claim 1 wherein said driver is active.

91. A system as claimed in claim 90 wherein said driver comprises a single-stage AC-DC power converter to convert said AC input power into said output power.

92. A system as claimed in claim 90 wherein said driver comprises a double-stage AC-DC and DC-DC power converter to convert said AC input power to said output power.

93. A method as claimed in claim 40 wherein said lighting system is driven passively.

94. A method as claimed in claim 40 wherein said lighting system is driven actively.

95. A method as claimed in claim 94 wherein said lighting system is driven by a single-stage AC-DC power converter to convert said AC input power into said output power.

96. A method as claimed in claim 94 wherein said lighting system is driven by a double-stage AC-DC and DC-DC power converter to convert said AC input power to said output power.

97. A system including a valley-fill circuit for generating a DC output voltage, said system including a parallel capacitor connected across said valley-fill circuit such that the voltage ripple of the DC output voltage is reduced.

98. A system as claimed in claim 97 further comprising a current source circuit to receive and convert said voltage ripple reduced DC output voltage into a current source, said current source thereby having a reduced current ripple.

99. A system as claimed in claim 98 wherein the current source circuit includes an inductor.

100. A system as claimed in claim 98 connected as an input to a load requiring a relatively constant current source.

101. A system as claimed in claim 100 wherein said load is an LED lighting system.

102. A method of generating a DC output by using a valley-fill circuit and a parallel capacitor connected across said valley-fill circuit such that the DC output voltage is generated with reduced voltage ripple.

103. A method as claimed in claim 102 further comprising converting the DC output voltage to a current source having a reduced current ripple.

104. A method as claimed in claim 103 wherein an inductor is used to convert the DC output voltage to a current source.

105. A method as claimed in claim 103 further comprising connecting the current source as an input to a load requiring a relatively constant current source.

106. A method as claimed in claim 105 wherein said load is an LED lighting system.
